(19) United States
(12) Patent Application Publication
(10) Pub. No.: US 2006/0155711 A1
(43) Pub. Date: Jul. 13, 2006

(54) Method and system for management of software product licences

(76) Inventors: Wayne A Jackson, Wellington (NZ); Vicky J McCullough, Auckland (NZ); Sheryl L Ching, Nelson (NZ)

Correspondence Address: NIXON & VANDERHYE, PC, 901 NORTH GLEBE ROAD, 11TH FLOOR, ARLINGTON, VA, 22203, US

(21) Appl. No.: 10/532,757

(22) PCT Filed: Nov. 5, 2003
(86) PCT No.: PCT/NZ03/00248

§ 371 Date: Sep. 2, 2005

(30) Foreign Application Priority Data
Nov. 5, 2002 (NZ) 52453

(51) Int. Cl. G06F 7/00

(52) U.S. Cl. 707/100

(57) ABSTRACT

The present invention relates to a method, system and software for management of software product licences. More particularly, a method of analysing software product licence data is disclosed. The software product licence data is received from a sales database. The data is then collated into an analysis database and an analysis of the data from the analysis database is displayed. Additional information for the analysis database may be provided by assessment of a licence ownership position for a customer, and determination of an appropriate licence agreement for a customer. User interface methods for selecting a software product of a vendor, linking two company names, and displaying linked company names are also disclosed.

### FIELD OF INVENTION

The present invention relates to a method and system for management of software product licences. More particularly, but not exclusively, the present invention relates to a method and system for analysing data about licensed software products to assess compliance.

### BACKGROUND TO THE INVENTION

Mass-market software products are often licensed to the user rather than sold outright. A licence can specify ways in which the product may be used, for how long, and other rights that may be available to the user—such as a right to future upgrades. Where the licensee is an organisation the licence may specify how many users are allowed to use the software product or across how many workstations the software product may be deployed.

In the last ten years it has become difficult for IT managers of organisations to manage software product licence compliance issues due to the multitude and complexity of different licence types available from the vendor and the varying types of licences for software products currently deployed in their organisation.

The different types of licences include volume licences—which are generally obtained from a reseller and are commercial licence agreements covering a specified number of workstations, servers or users; OEM licences—which come with software bundled with hardware obtained from a hardware supplier; and FPP (Fully Packaged Product) licences—which come with software purchased boxed with media and manuals. Volume licences are generally recorded on the vendor's main database, but most OEM and FPP licences do not have compulsory registration requirements and consequently information about such licensees are not immediately available to the vendor.

Furthermore, there are a number of different types of volume licences. For example MICROSOFT™ software product volume licences include Standard licences which licence the use of a specific version of a product and Upgrade licences which replace entitlement to a specific version with entitlement to a later version. Maintenance contracts may be purchased to provide additional upgrade rights for a fixed time period, typically two years. The licenses covered by the contact earn automatic upgrades to any new versions released during the period of cover. In addition, MICROSOFT™ has different types of volume agreements, known as Enterprise, Select and Open Agreements. The type of agreement suitable for a particular organisation will depend on the size of the organisation, its commitment to Microsoft product use, and also its ability to forecast purchase volumes. Enterprise Agreements are appropriate for medium to large organisations that deploy Microsoft products on each desktop. Select Agreements also suit medium to large organisations, but allow for variable levels of usage within that organisation. Open Agreements can be used by organisations of any size, but typically suit small to medium sized organisations.

Furthermore, resellers of software products require an easy-to-use system which provides them with a way to offer customers licensing options customised to the customers' business.

In addition, some vendors lack a comprehensive system which can analyse sales of volume licences to particular customers integrated with what they know about the customer's organisation, especially in relation to the estimated number of computer workstations and servers, and with the existence of other licences owned by the customer. Such analysis can be helpful in identifying compliance issues with customers and identifying marketing opportunities.

Presently, vendors are either required to regularly undertake audits of customers' systems to ensure compliance (report-based) or to rely on the customer to comply with the licence agreement (honesty-based). The disadvantage of the first option is cost and the disadvantage of the second is, as stated, IT managers may not even be aware that they are not in compliance with the licence. Some reports place the figure of unlicensed software used in business at 26%.

One known system for analysing software product licence data is a system of EXCEL™ spreadsheets and macros used to analyse data from the MICROSOFT™ volume licence sales database.

This system has a number of disadvantages. Firstly, it only covers volume licence sales which will give an imperfect view of customer compliance. Secondly, it is difficult to interpret and determine how different licence types combine to create an actual license ownership position. And thirdly, it has poor capacity to record and integrate information recovered from the customer.

### SUMMARY OF THE INVENTION

It is an object of the present invention to provide a method and system for management of software product licences which resolve the above issues or to at least provide the public with a useful choice.

Data Flow Method

According to a first aspect of the invention there is provided a method of analysing software product licence data including the steps of:
i) receiving the data from a sales database;
ii) collating the data into an analysis database; and
iii) displaying an analysis of the data using the analysis database.

Preferably, the sales database is the database of a software product's vendor. The data from the sales database may include transaction data about volume licence sales to customers. The data may also include product lists of available software products.

In a preferred embodiment of the invention the data is received from a vendor sales database in a batch feed. The batch feed may occur on a monthly, bi-weekly, or weekly basis.

Preferably, data received from the sales database is cleaned before it is collated into the analysis database. Cleaning the data may include correcting inconsistencies in transaction data—such as duplicate agreements, or inconsistencies with the existing analysis database—such as differing master agreement end-dates. If the data includes products lists then cleaning the data may include determining new products from the product list and updating the analysis database accordingly.

Preferably, the method includes the step of interacting with the customers of the vendor to obtain correct customer data, other licence data, and actual software installation data. This data may be incorporated into the analysis database. This step may be the method of the fifth aspect (described below).

The data analysis may include an assessment of licence ownership and an assessment of licence compliance.

The data analysis may also include transaction data analysis, licence agreement analysis, reseller analysis, customer compliance lists, customer segment analyses, product analysis, and annuity renewal analysis.

The assessment of licence ownership may be displayed for each customer in a summary screen showing products owned by the customer, licences owned for those products by the customer, and a total assessed ownership for each product for the customer. The summary screen may further include a section showing upgrade licences owned by the customer. The section may indicate show an assessment of upgrade licenses which have no identifiable base licenses.

The assessment of licence ownership may further display an option to view a derivations screen showing the derivation of calculations in the summary screen.

The assessment of licence compliance may be displayed for each customer in a summary screen showing (i) products/licences owned by the customer, (ii) products actually installed/used by the customer, and the discrepancy between (i) and (ii).

An additional step may exist before step (iii) wherein a user may specify criteria to determine how the data is to be analysed or what portion of the data is to be analysed. When the data analysis is a customer compliance list the criteria may include the segment of business, assigning risk weightings to one or more factors, how the list is to be ordered, or a time frame. When the data analysis is an annuity renewal analysis the criteria may include a data range, types of annuity programs/licences, segment of business, product set, or how the list is to be ordered.

Preferably, the data analysis is displayed on a GUI.

The method may include the step of transmitting corrected customer data to a vendor CRM database.

Method for the Graphical Display of Ownership and Compliance

According to a second aspect of the invention there is provided a method of displaying an analysis of software product licence data including the steps of:
i) displaying an assessment of the number of computer users in an organisation using a first graphical characteristic; and
ii) displaying the current number of software product licences owned by the organisation for products of a vendor using a second graphical characteristic.

Preferably, the second graphical characteristic consists of bars representing each product and the first graphical characteristic is a line, perpendicular to the direction of the bars, overlaid on the bars. The bars may be colour-coded to indicate the different types of licenses. Where a number of licences are owned by the organisation for one software product the bar may be coded the colour of the numerically dominant licence type and the other licences may be represented as smaller bars overlaid on this bar. Alternatively, the bar may be coloured-coded a colour representing the licence ownership position for that software product and all the licences owned by the organisation may be represented as smaller bars overlaid on this bar.

Licence Ownership Position (LOP) Workbench

According to a third aspect of the invention there is provided a method of displaying a licence ownership position for a vendor's software products for a customer including the steps of:
i) retrieving software product licensing data from a sales database;
ii) retrieving other software product licence data from the customer;
iii) retrieving assessed use of the software products by the customer,
iv) calculating a licence ownership position; and
v) displaying the licence ownership position and assumptions about calculations in a GUI.

A licence ownership position (LOP) is an assessment of the customer's licensing compliance arrived at by taking all available data which may include the number—or estimated number—of computer users in the customer's organisation, the number of commercial licences sold to the customer, the relationship between base licenses, upgrade licenses, and licences accrued via maintenance contracts, other licences owned by the customer—for example OEM and FPP licences, and various assumptions, and calculating how many effective software licences the organisation has.

The licence ownership position may be calculated by combining different licence types and aggregating purchases totals.

Preferably, the method retrieves the data from the analysis database created using the first aspect of the invention.

Preferably, the sales database is the sales database of the vendor.

The method may include the step of calculating and displaying the risk of non-compliance. This may occur with comparison to actual installation data or actual/estimated computer user data.

The licence ownership position may be recorded and may be used when later LOPs are calculated.

The estimated licensing position may be refined by providing more data or more reliable data.

Agreement Modelling

According to a fourth aspect of the invention there is provided a method of determining software product licensing schemes for a customer including the steps of:
i) retrieving data from an analysis database created in the first aspect;
ii) retrieving customer requirement data; and
iii) calculating possible licence schemes.

The data retrieved from the analysis database may include current compliance or non-compliance with licensing schemes by the customer, and data about existing software product licences owned by the customer.

The customer requirement data may include intended deployment of software products over a specified time (for example the next 3 to 5 years) and “soft cost” data relating to administration costs of certain types of licensing schemes.

The licence schemes may include total costs, annual costs, and net-present-value considerations. Costs may include intangible costs such as cost of administration, audits, etc.

The method may include the step of displaying a graphical comparison of the licence schemes.

The method may select the best possible or most appropriate licensing schemes for the customer.

Call Center Workbench

According to a fifth aspect of the invention there is provided a method of recording customer data including the steps of:
i) prompting questions to ask a customer;
ii) recording the responses given by the customer; and
iii) integrating the responses into the analysis database of the first aspect of the invention.

The questions may include questions relating to software users within the customer's organisation, general details about the organisation—for example organisation name, address, and details of subsidiaries. The questions may also include questions designed to assist the capture of anecdotal information about product use, user counts, and non-volume licence purchases.

The types of questions prompted may be determined by the lack of certain data, the existence of certain data, or the reliability of certain data within the analysis database.

Responses provided may automatically update the analysis database and further questions may be based on responses previously supplied.

The method may include the step of retrieving compliance/non-compliance data from the analysis database. This data may be used to direct the focus of the questions prompted.

Method for Selecting a Software Product Version

According to a sixth aspect of the invention there is provided a method for selecting a software product of a vendor including the sequentially occurring steps of:
i) displaying a plurality of panes within a GUI;
ii) selecting a product type from a list of product types under category headings within a first pane;
iii) selecting a product variation from a list of product variations within a second pane; and
iv) selecting a product version from a list of product versions within a third pane.

The software products may comply with software vendor labelling methodology.

The first pane may list the vendor's most popular product types under each category. Preferably, the category headings under the first pane include “Applications”, “Servers”, and “Systems”.

The method may also include the step of selecting a licence type of the software product within the third pane.

The selection of a product type within the first pane may determine the product variations listed in the second pane. Selection of the product type may be confirmed by actuation of a button within the first pane.

The selection of a product variation within the second pane may determine the product versions listed in the third pane. Selection of the product variation may be confirmed by actuation of a button within the second pane.

The method may be used to record or update actual installation data of the software product in a customer's organisation.

Method for Linking Parent-Child Company Names

According to a seventh aspect of the invention there is provided a method for linking two company names including the steps of:
i) entering a first company name abbreviation in a first region;
ii) populating a first list within a second region with company names which correspond to the first company name abbreviation;
iii) selecting a first company name from the list;
iv) entering a second company name abbreviation in a third region;
v) populating a second list within a fourth region of company names which correspond to the second company name abbreviation;
vi) selecting a second company name from the second list; and
vii) linking the first company name with the second company name.

Preferably, the company names are linked because the first company name is the parent or child of the second company name, the first company name is the former or present name of the second company name, or the first company name is an alternative name of the second company name.

The first and second company name abbreviations may be a search string for a part of a company name.

The first and second lists may include the company name and its “link status”—i.e. not linked, a parent, a child.

Method for Displaying Company Name Parent-Child Links

According to an eighth aspect of the invention there is provided a method for displaying linked company names including the steps of:
i) displaying a list of one or more primary company names;
ii) displaying under each primary company name one or more secondary company names linked to the primary company name; and
iii) displaying one or more graphical characteristics each representing the link between each secondary company name and its corresponding primary company name.

Preferably, the company names are linked because the primary company name Is the parent of the secondary company name, the secondary company name is the former name of the primary company name, or the secondary company name is an alternative name of the primary company name.

Preferably, the secondary company is displayed under and indented with respect to the primary company name.

The method may include the steps of displaying one or more tertiary company names each linked to a secondary company name under their respective secondary company names and one or more graphical characteristics representing each link.

Preferably, the graphical characteristics used to represent the link are “L-shaped” branches.

Systems for Implementing the Methods

According to a ninth aspect of the invention there is provided a system for implementing the method of any one of the first to eighth aspects of the invention.

Software for Effecting the Methods

According to a further aspect of the invention there is provided software for effecting any one of the preceding methods.

### BRIEF DESCRIPTION OF THE DRAWINGS

The invention will now be described by way of example with reference to the accompanying drawings in which:

FIG. 1: shows a flow diagram illustrating a preferred embodiment of the method of the first aspect.

FIG. 2: shows a screenshot illustrating the analysis tools available.

FIG. 3: shows a screenshot illustrating an overview of an organisation's licence compliance.

FIG. 3a: shows a screenshot illustrating an alternative overview of an organisation's licence compliance.

FIG. 4: shows a screenshot illustrating a summary of licence ownership and compliance.

FIG. 4a: shows a screenshot illustrating a consolidated compliance position for a customer.

FIG. 4b: shows a screenshot illustrating a licence ownership position summary screen for a customer.

FIG. 4c: shows a screenshot illustrating a licence ownership position derivation screen.

FIGS. 5, 6, 8, and 10: show screenshots illustrating different ways of viewing data stored in the analysis database.

FIGS. 7 and 9: show screenshots illustrating a process for selecting a software product version and licence type.

FIGS. 11 to 13: show screenshots illustrating a method of prompting questions to be asked of a software product licence customer.

FIGS. 14 to 17: show screenshots illustrating a method of displaying and specifying links between different company names.

FIGS. 18A to 21: show spreadsheets illustrating the various aspects of agreement modelling.

FIG. 22: shows a flow diagram illustrating a preferred embodiment of the method of the third aspect.

FIG. 23: shows a screenshot illustrating a customer compliance metrics screen.

FIG. 24: shows a screenshot illustrating a customer compliance report.

FIG. 25: shows a screenshot illustrating how information displayed in customer compliance report may be edited.

FIG. 26: shows a screenshot illustrating projected revenue for annuity renewals.

FIG. 27: shows a screenshot illustrating a customer annuity criteria screen.

FIG. 28: shows a screenshot illustrating a customer annuity report.

### DETAILED DESCRIPTION OF PREFERRED EMBODIMENTS

The present invention relates to a method and system for managing software product licences. The invention will be described in relation to the licensing of MICROSOFT™ software but could be used in relation to the licensing of software for other vendors with appropriate modifications.

Data Flow Method

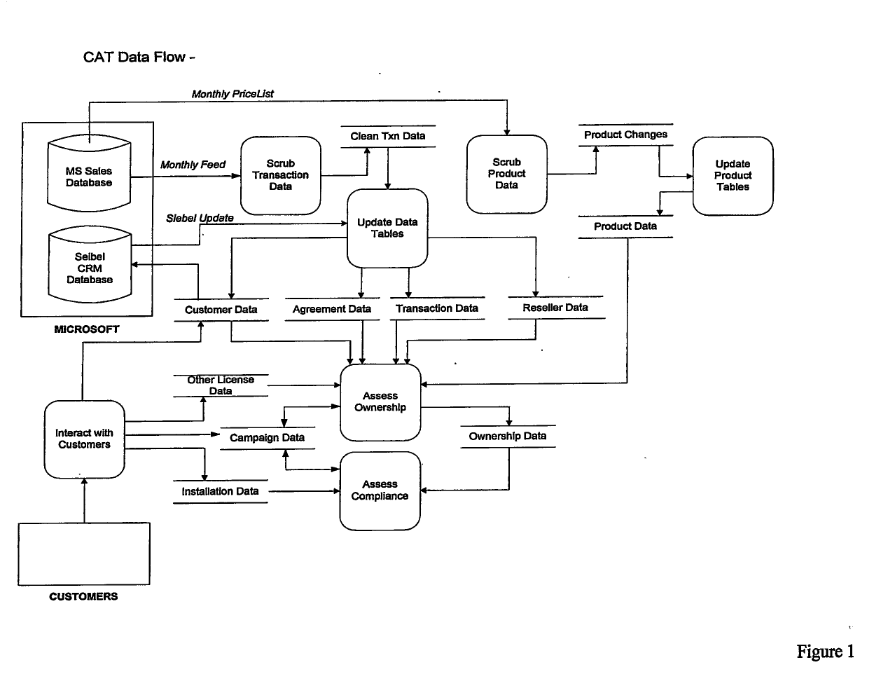

Referring to FIG. 1, a preferred embodiment of the first aspect of the invention will be described.

The central MICROSOFT™ Sales Database provides a monthly batch feed of transaction data. It will be appreciated that the feed may be provided bi-weekly, weekly, or in any time period. The MS Sales Database typically records volume licence transactions recorded by MICROSOFT™ when it sells the licence or transmitted to MICROSOFT™ by a reseller when it sells the licence.

The data is scrubbed (cleaned) by a series of processes. Some or all of these processes may be automated. These processes can include correcting inconsistencies in transaction data—such as duplicate agreements, or inconsistencies with the existing analysis database—such as differing master agreement end-dates. The result of these processes is Clean Transaction Data which is provided to update the analysis database represented by a series of tables—customer data, agreement data, transaction data, reseller data.

The MlCROSOFT™ Sales Database also provides a monthly pricelist of current software products. This may include licence information. This pricelist is scrubbed by a series of processes, of which some or all may be automated. The result of the scrubbing process is a list of new products or changes to existing products. This information is consolidated into the product data table which also forms part of the analysis database.

Interaction with the customer can occur. This interaction can be directed by the call center workbench (see the call center workbench section). This interaction may provide the following results:
It may be revealed that the customer is associated with another company name in the analysis database. This association can be a parent-subsidiary relationship with the other company or it may be that other company name is a former name, other name, or erroneous recordal of the customer's actual name. In any case this association can have ramifications in relation to licence data recorded against it. The associations may be recorded using the parent-child links method (see the method for linking parent-child company names section).
It may be revealed that customer has acquired other licences such as OEM licences or FPP (Fully Packaged Product) licences which may not be initially recorded in the analysis database. The customer may also have acquired volume licences by acquisition of another company. (see the method for entering other licence data section for the way in which this other licence data may be recorded or changed).
Information about how many and the type of software products actually installed in customer's organisation may be revealed by this interaction. (See the method for entering actual installation data section for details on how this data may be recorded or changed) This actual installation data may be used to establish a risk of non-compliance (see the licence ownership position (LOP) workbench section).

In this example the ownership of licences is assessed. Conclusions reached from this assessment are stored in the ownership table which is part of the analysis database. This assessment is called the licence ownership position (see the licence ownership position (LOP) workbench section for details of its calculation).

In this example the compliance of licences is assessed. Data is retrieved from the ownership table representing the licence ownership position. This is compared with data from the installation data table which represents how the software products are actually deployed. The result of this assessment can be the risk of non-compliance. This risk could include the monetary cost of compliance.

In this example customer data retrieved from the customer during interaction may be fed back to the vendor's customer relations management (CRM) database.

In this example, feeds from the CRM are also received on a monthly basis. The data received from the CRM includes PC count, business segment classification, contact names, contact addresses, contact phone numbers and email addresses. This information may be used to populate the screens used in calling campaigns. A calling campaign is a compliance review or audit targeting a particular segment of the customer base.

Interaction with the customer during a calling campaign is used to provide data for a campaign data table. The campaign data table contains information about customers and their actual use of Microsoft technology (as opposed to their license ownership). This is called “anecdotal” data, which is useful for gaining a complete picture of the customer's compliance status. The campaign data tables are initially populated in part using data received from the CRM system. The other fields are populated and updated as the campaign calling takes place.

From this “anecdotal” information, the range and extent of Microsoft product usage may be deduced for comparison with license ownership to gauge compliance.

Analyses Menu

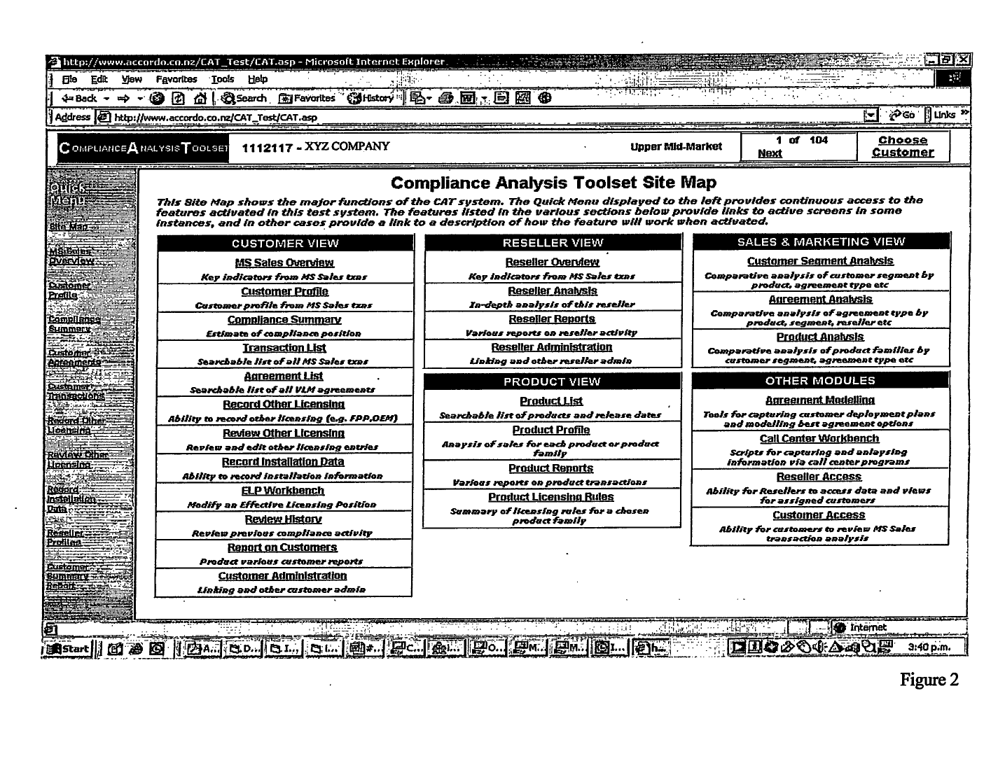

FIG. 2 shows a number of different analyses that may be undertaken in relation to the analysis database.

Method for the Graphical Display of Ownership and Compliance

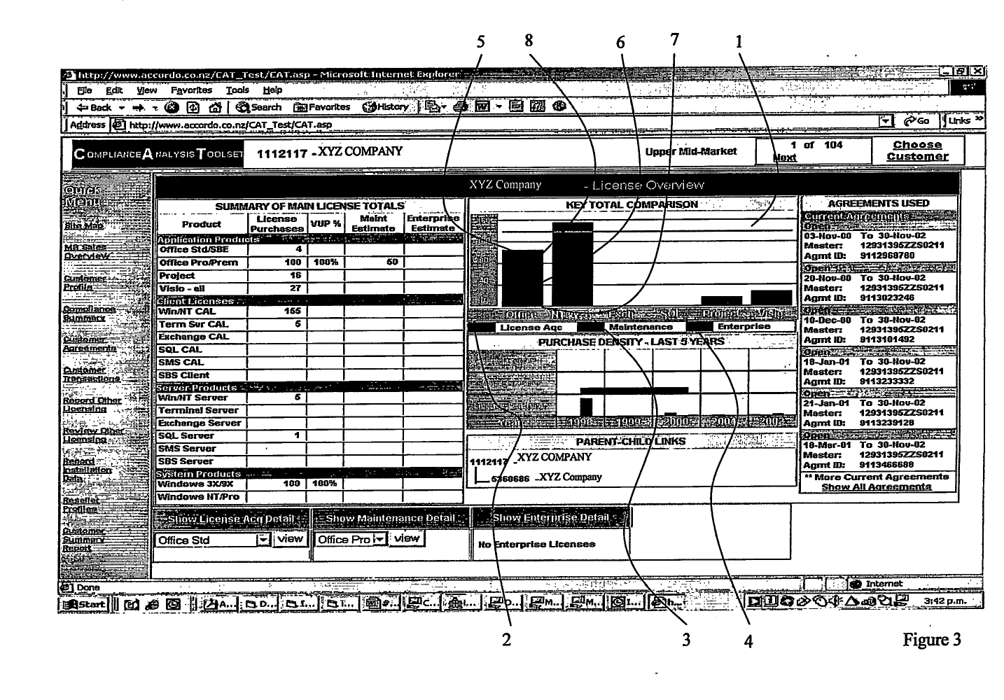

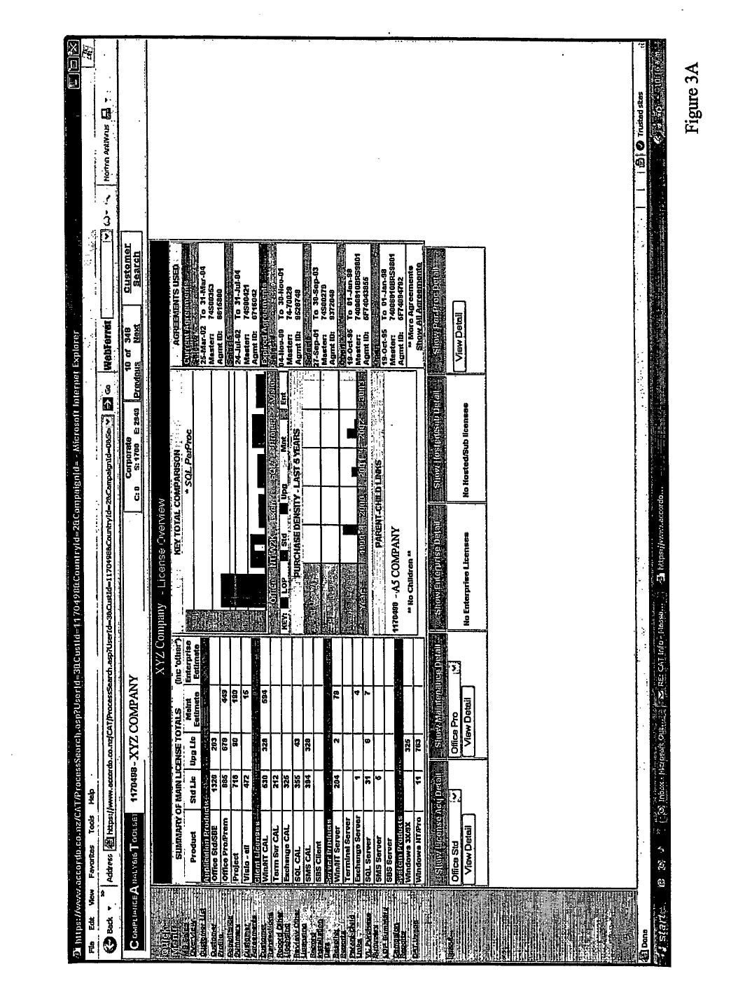

FIG. 3 shows how data about assessed ownership for a particular customer may be displayed.

The Key Total Comparison Chart within FIG. 3 shows a method of displaying assessed ownership and approximated installation data to allow for an easy assessment of compliance.

The approximated installation data, in this example, is the estimate (or actual) number of seats in the organisation. This is represented by the green horizontal line 1. It will be appreciated that a similar graphical characteristic may be used.

The assessed ownership is shown as bars representing the estimated (or actual) licences, for a number of popular software products, owned by the customer. In this example this includes the following MICROSOFT™ products: OFFICE™, WINDOWS NT/WINDOWS 2000™, EXCHANGE SERVER™, SQL SERVER™, PROJECT™, and VISIO™. In this example the following MICROSOFT™ licences are shown: Standard Licence (red) 2, Maintenance Licence (dark red) 3, and Enterprise Licence (green) 4.

In this example each bar is divided into three thin bars, each smaller bar represents one of the three licences owned by the customer for that software product. The OFFICE™ bar contains a thin red bar 5 of height 100, a thin dark red bar 6 of height 50, and a thin green bar 7 of height zero. The thin bar which is dominant in height determines the colour and height of the thicker bar which sits behind all three thin bars. In this example, the thin red bar 5 dominates in height and therefore the thicker bar 8 is all red and has a height of 100.

Referring to FIG. 3a a screenshot for an alternative overview will be described.

The Key Total Comparison Chart in FIG. 3a differs from FIG. 3 in that each bar represents the calculated licence ownership position for that product and a plurality of thin bars, representing the different types of licences owned for that product, are overlaid on the thicker bar.

Display of Licence Ownership and Compliance Table

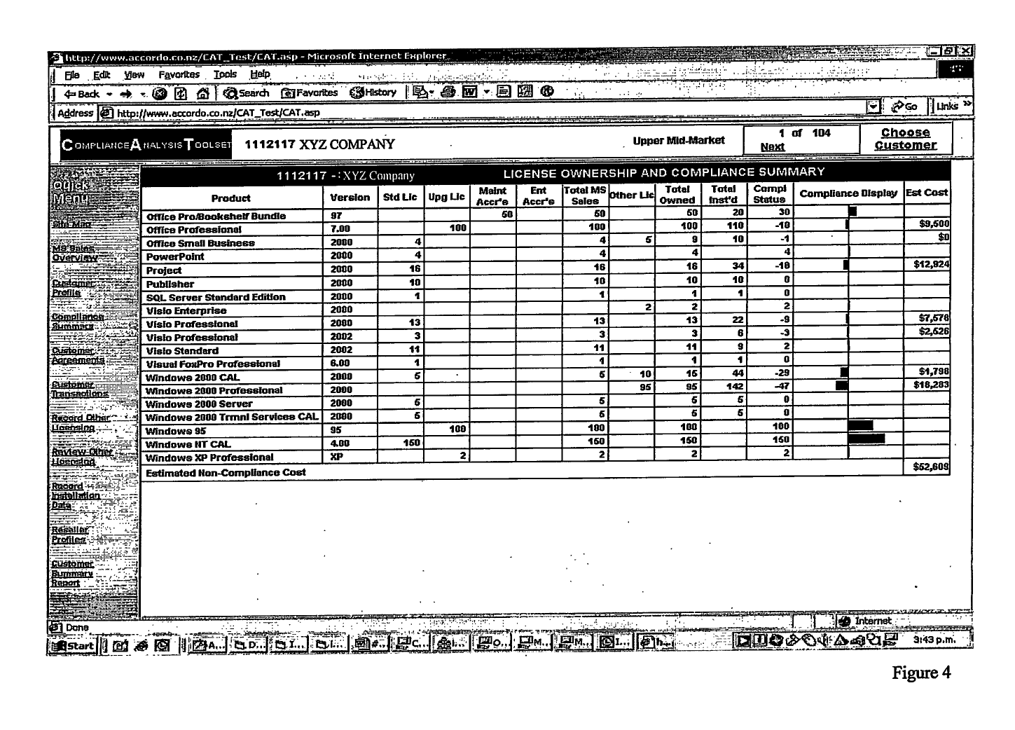

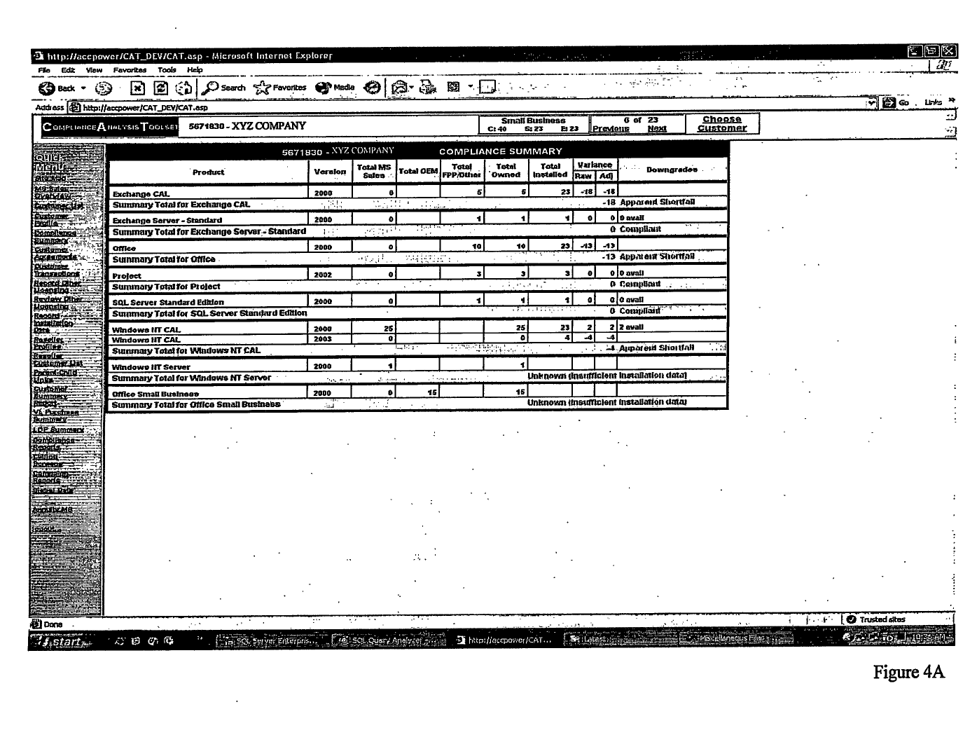

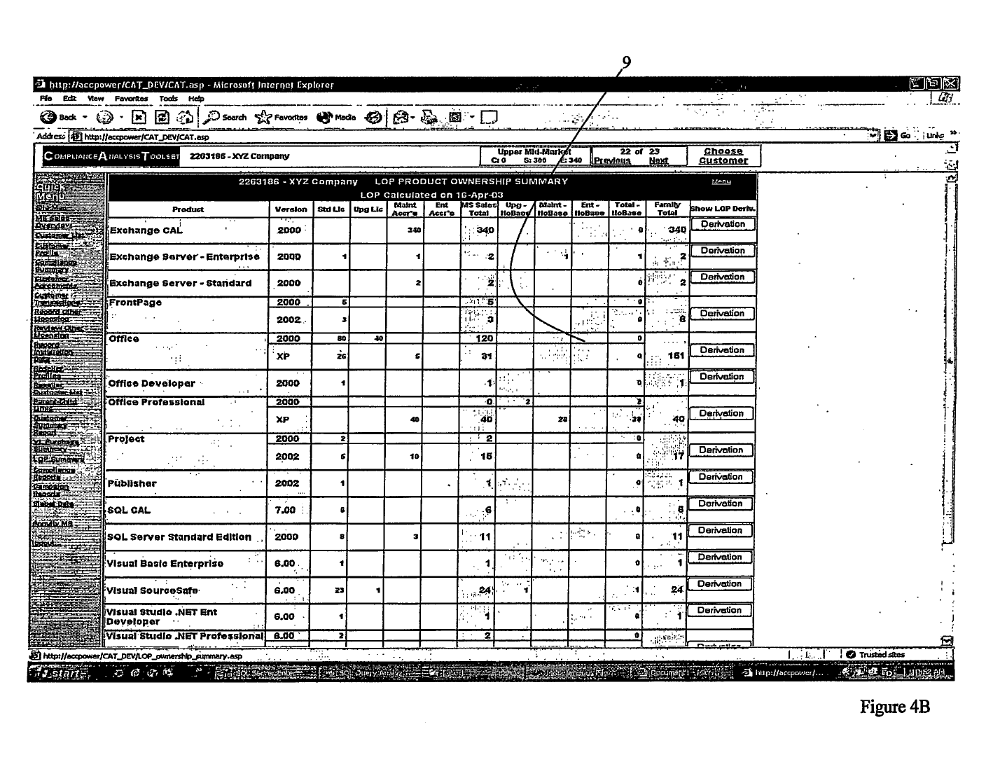

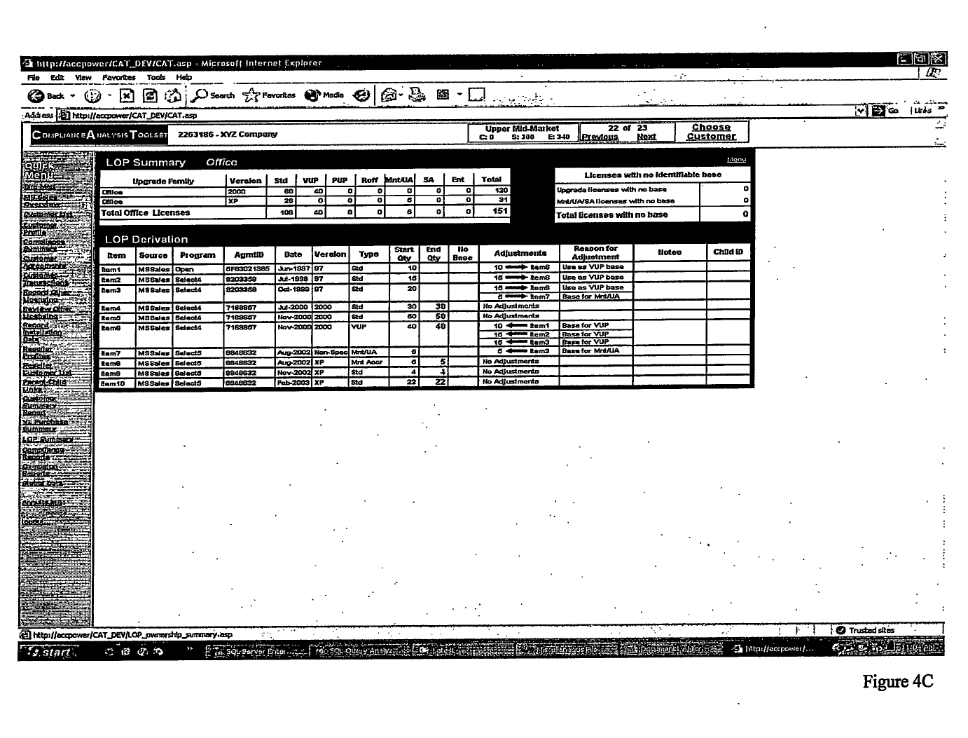

FIG. 4 shows a table displaying licence ownership and compliance data. The table includes an assessment about the cost required to bring the organisation into compliance.

The Total MS Sales column is computed from the sum of all volume licences owned by the customer for each product version.

The Total Owned column is computed from the sum of the Total MS Sales column and other licences owned by the customer (i.e. OEM and FPP licences).

The Compliance Status column shows the difference between the Total Owned licences column and the Total Installed licences column (which is created from information recovered from the customer).

A graphical compliance display showing compliance/non-compliance is shown in this example.

A final column, Estimated Cost, shows the estimated cost to comply with the licence requirements which is calculated by multiplying the Compliance Status number by a RRP for one licence for the specific software product.

FIG. 4A shows a consolidated compliance position for a customer, taking into account the following:
The overall licence ownership position (LOP) calculated separately by another part of the system from Microsoft volume licence records;
Information gathered from customer interaction regarding licences purchased by means other than volume licensing programs;
Information gathered from customer interaction regarding actual use and installation of Microsoft products;
The ability of the customer to use downgrade rights to achieve licensed use of Microsoft products—i.e. use of unallocated licences of later versions to validate the installation of previous versions.

For each product family, this screen shows a net compliance position, or indicates that such a position cannot be concluded due to a lack of complete installation data

FIG. 4B shows a licence ownership position summary screen for a customer.

The rows in the screen are grouped by product family. Within each family, the versions for which some licences are held are shown, and the types of licences (e.g. standard, upgrade, maintenance etc) are itemized.

A total of MS Sales licences are shown for each version, together with a total for the family as a whole.

Some licence types require a base (e.g. an upgrade licence requires a licence of an earlier qualifying product), and section 9 displays where such base licences have not been identified.

The “Derivation” button leads to a screen which displays how the ownership position was arrived at.

FIG. 4C shows a licence ownership position derivation screen.

This screen shows an audit trail of how the consolidated ownership position was reached for a particular product family. This includes the use of base licences for upgrades, the use of base licences for maintenance licences etc. It also highlights where base licences were required but not found.

Display of Transaction Data Analysis

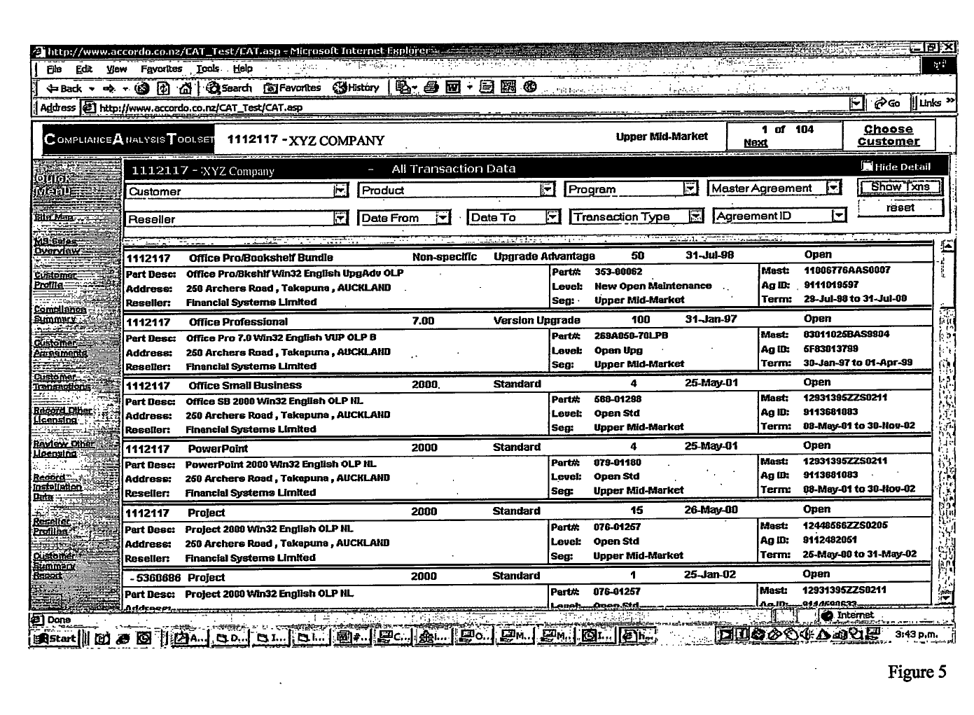

FIG. 5 shows a GUI for querying the analysis database to obtain details about transaction data for a particular customer.

Display of Licence Agreement Analysis

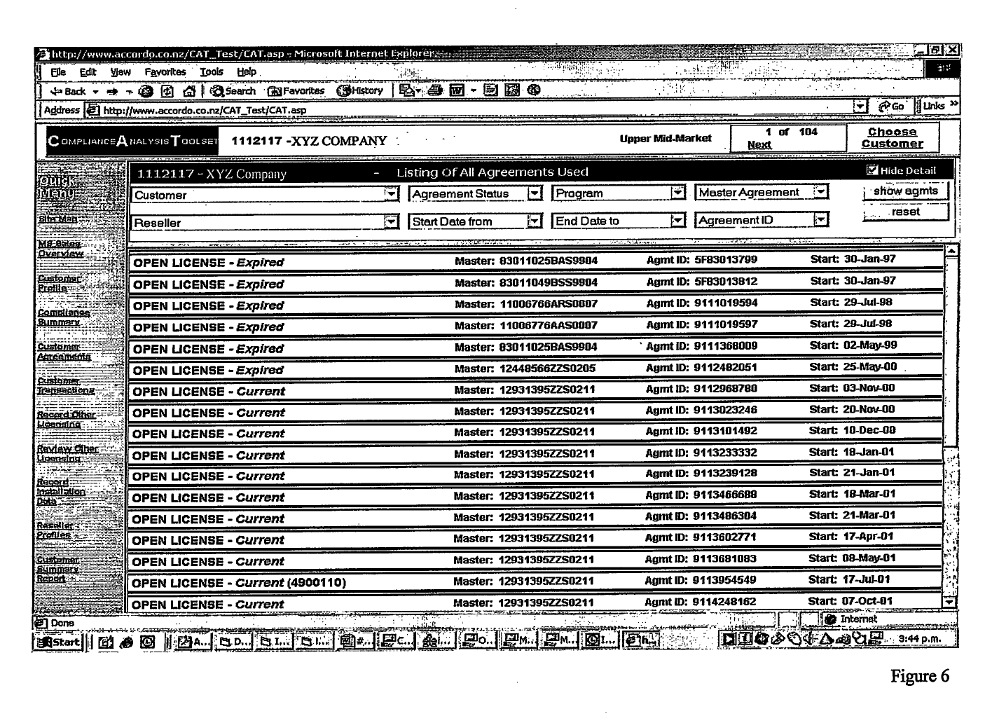

FIG. 6 shows a GUI for querying the analysis database to obtain details about historical and current licence agreements for a particular customer.

Method for Entering Other Licence Data

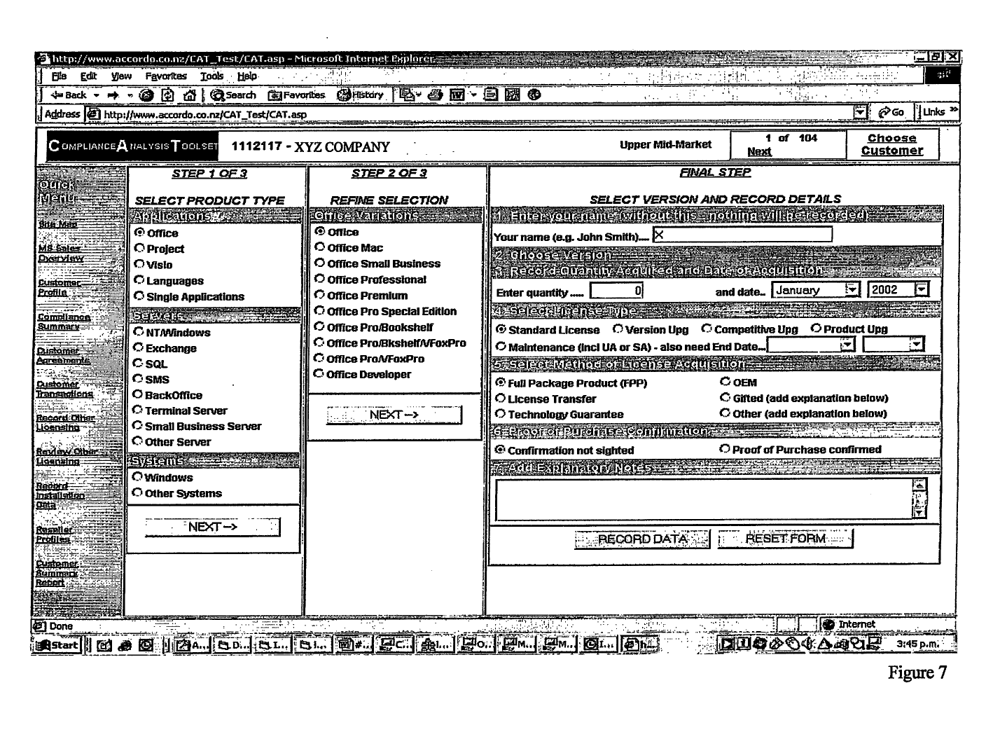

FIG. 7 shows a GUI for entering licence details about a particular MICROSOFT™ software product licence other than volume licences.

A first pane, STEP 1 OF 3, is provided from which product type can be selected using a radio button. The product types are categorised under three headings—Applications, Servers, and Systems. When the NEXT→button at the bottom of the pane is actuated the next pane updates to show the available product variations for that product type. Within this second pane, STEP 2 OF 3, a product variation may be selected from a list using a radio button. When the NEXT→button at the bottom of this second pane is actuated the next pane updates to show details about that product variation. Within this third pane, FINAL STEP, the following selections can be made: product version, licence type, method of licence acquisition, and whether the proof of the licence acquisition has been confirmed. In addition, data about how many licences have been acquired can be entered.

When the RECORD DATA button at the bottom of the third pane is actuated the details entered in the third pane will be recorded in the analysis database, following a confirmation step in which the user is prompted to correct any inconsistent data entries or supply required fields that have been left blank.

Display of Other Licence Analysis

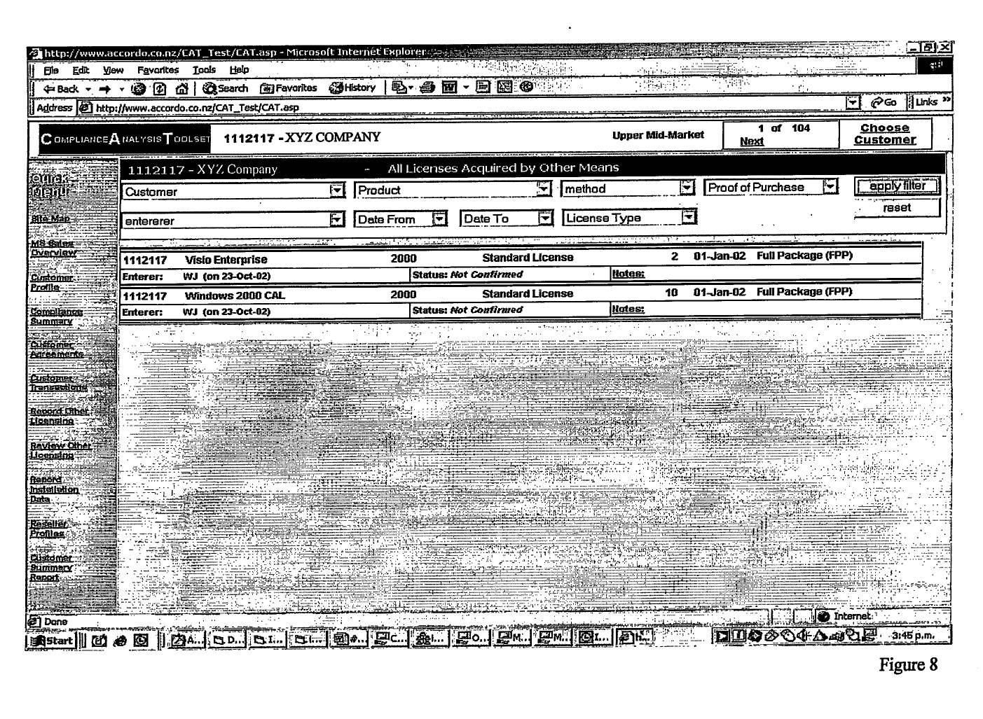

FIG. 8 shows a GUI for querying the analysis database to obtain details about licences acquired by means other than volume licence purchases for a particular customer.

Method for Entering Actual Installation Data

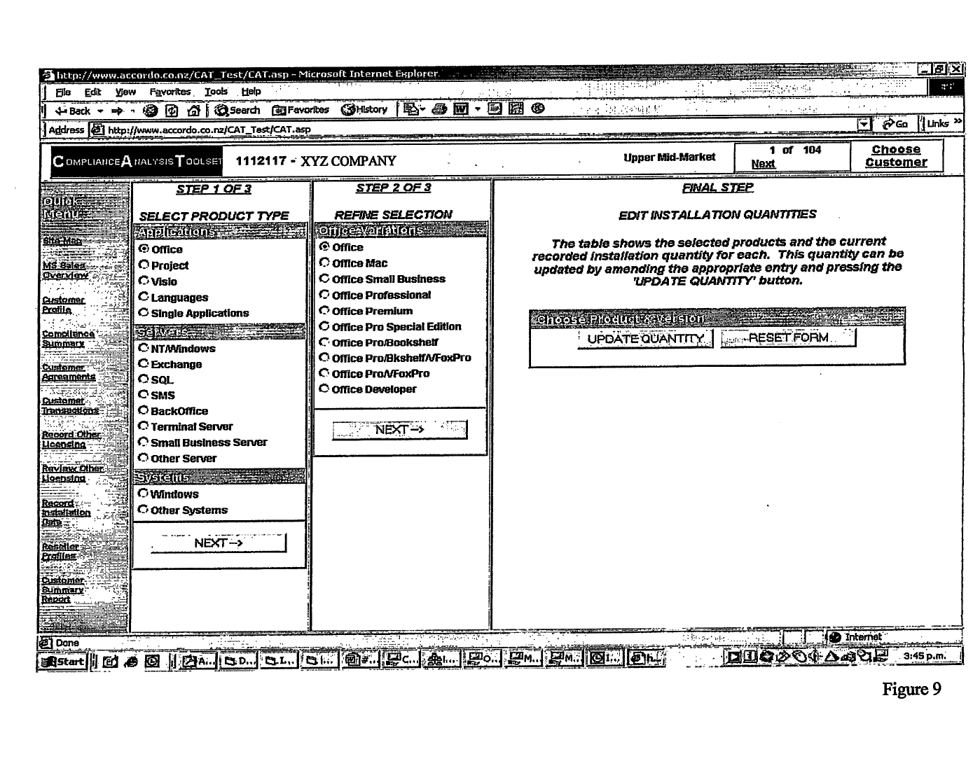

FIG. 9 shows a GUI for entering actual customer installation data about a particular MlCROSOFT™ software product.

This GUI operates in the substantially similar way to the GUI described under the method for entering other licence data however, the details provided within the third pane include the number of software products actually installed rather than the types of licences owned.

This data may also be recorded in the analysis database.

Display of Reseller Analysis

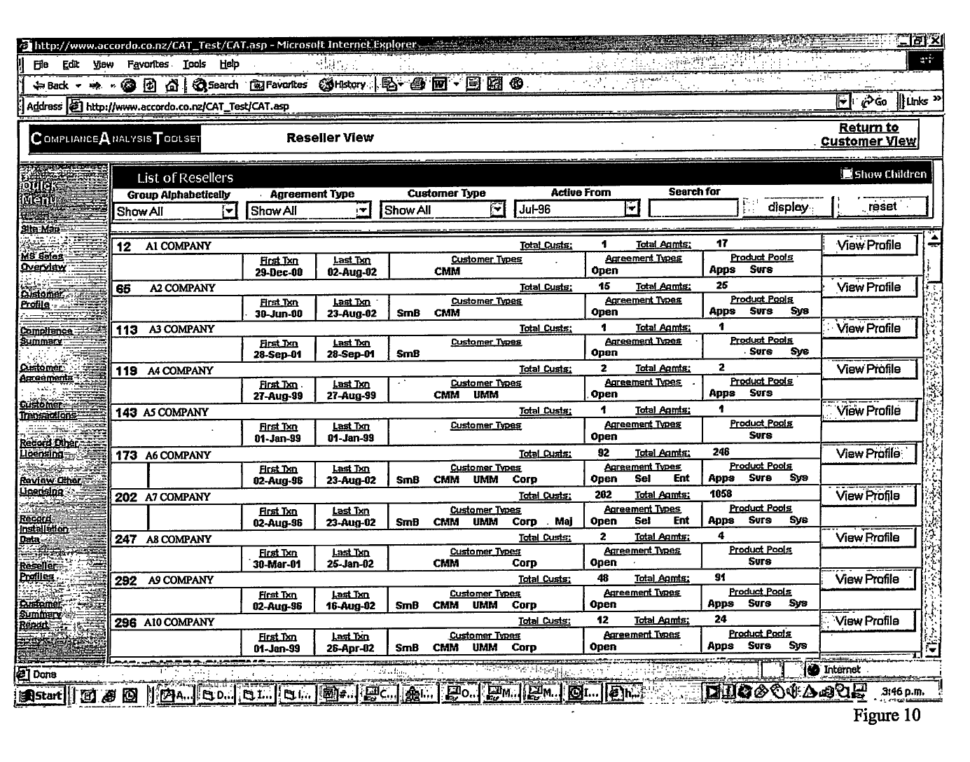

FIG. 10 shows a GUI for querying the analysis database to obtain details about resellers of the vendor's software products.

Call Center Workbench

There is a need to support people engaged in outbound calling, particularly in the area of compliance reviews and auditing. At all stages of this activity, the need for ready access to reliable, informative information about the customer's purchasing history is a key success factor in terms of revenue generation and customer satisfaction.

The aim of this method is to integrate scripting functionality and provide links to other sections of the invention.

The method will facilitate the capturing of key organizational data, anecdotal information about product use, user counts, and non-volume license purchases.

In summary, the call center workbench provides prompts to assist a call centre operator in interaction with a customer to obtain information about the customer's organisation.

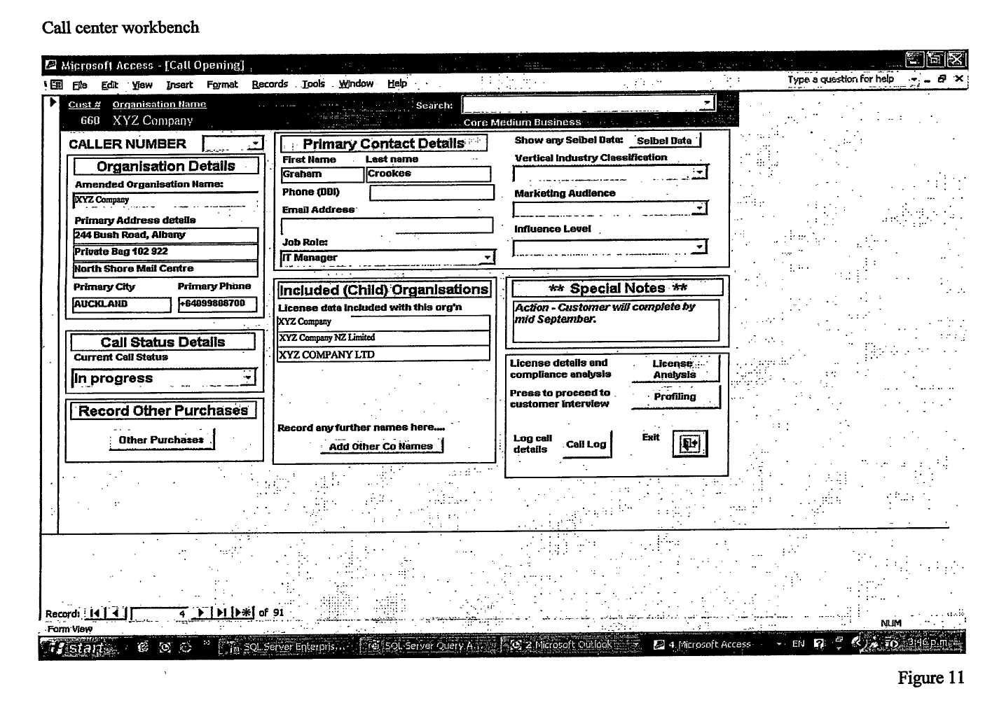

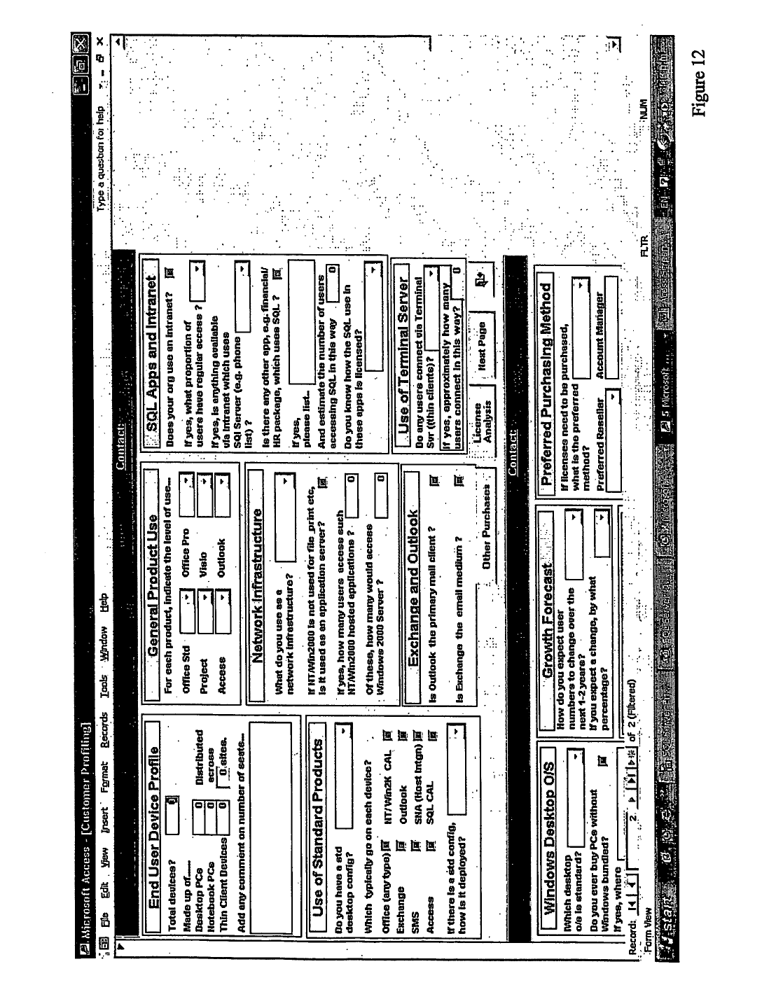

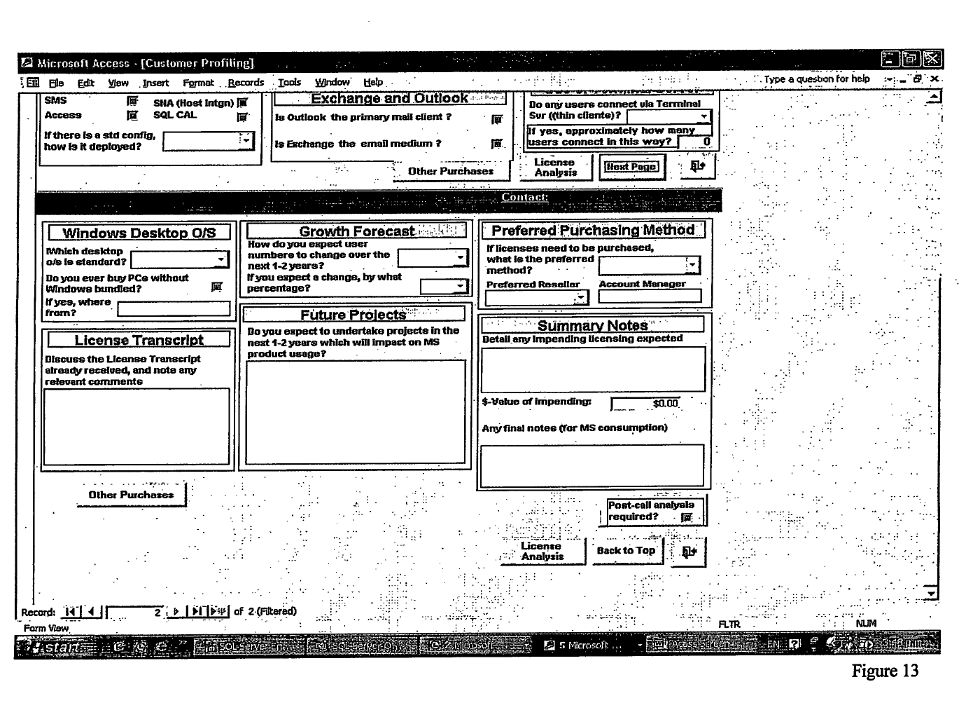

FIGS. 11 to 13 show how the call center workbench operates.

This method provides questions which a call center operator can use to query customers to establish details about the customer's organisation.

The questions include:
general organisation details such as name and address
primary contact details
end user device profile to determine the number and types of computing devices within the organisation
use of standard products such as a typical desktop configuration
general product use to indicate the level of use of popular products
details about the network infrastructure
EXCHANGE™ and OUTLOOK™ mail systems
SQL Applications and Intranet details
use of terminal server
typical windows desktop O/S
licence transcript
growth forecast
future projects to be undertaken
preferred purchasing method including preferred reseller used
summary notes about impending licenses

In this example, the method provides for detailed questions about other licences acquired to be asked and recorded using the method for entering other licence data (shown in FIG. 11 under Record Other Purchases).

The method can also provide for detailed questions about actual installation data to be asked and recorded using the method for entering actual Installation data.

In this example, the method provides for questions about associated company names to be asked and recorded using the method for linking parent-child company names (shown in FIG. 11 under Included (Child) Organisations).

The responses are recorded and integrated into the analysis database.

Parent-Child Company Name Links

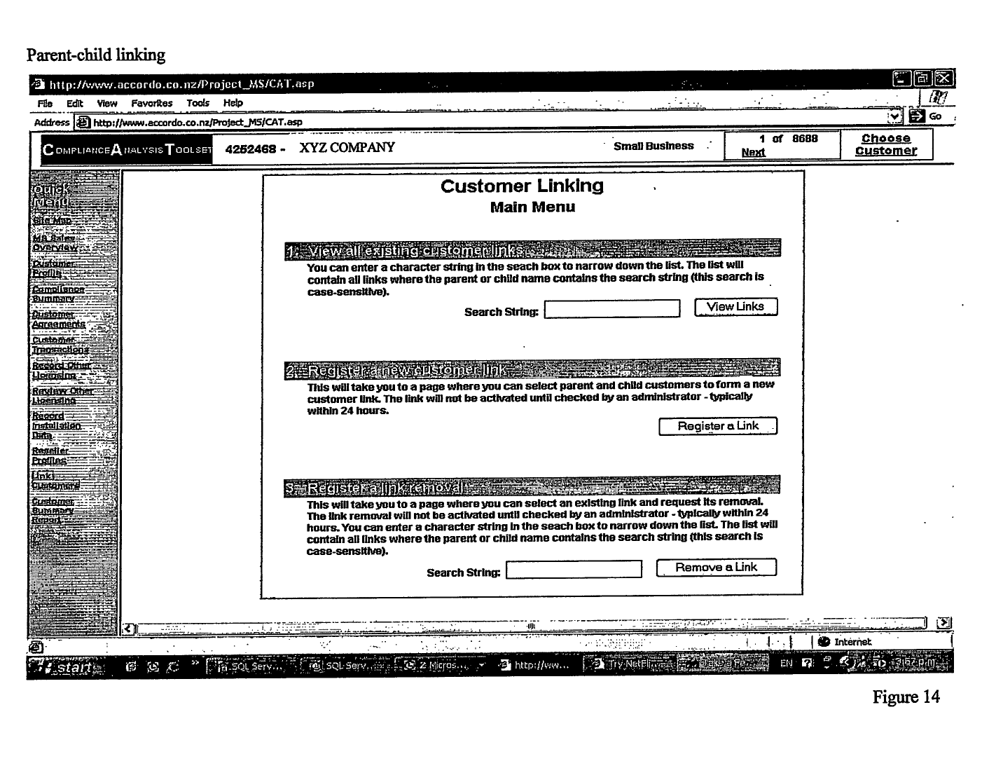

FIGS. 14 to 17 show screenshots of how company name links can be viewed, registered, or removed.

FIG. 14 provides a menu to three options: view all existing customer links, register a new customer link, and register a link removal.

Method for Displaying Company Name Parent-Child Links

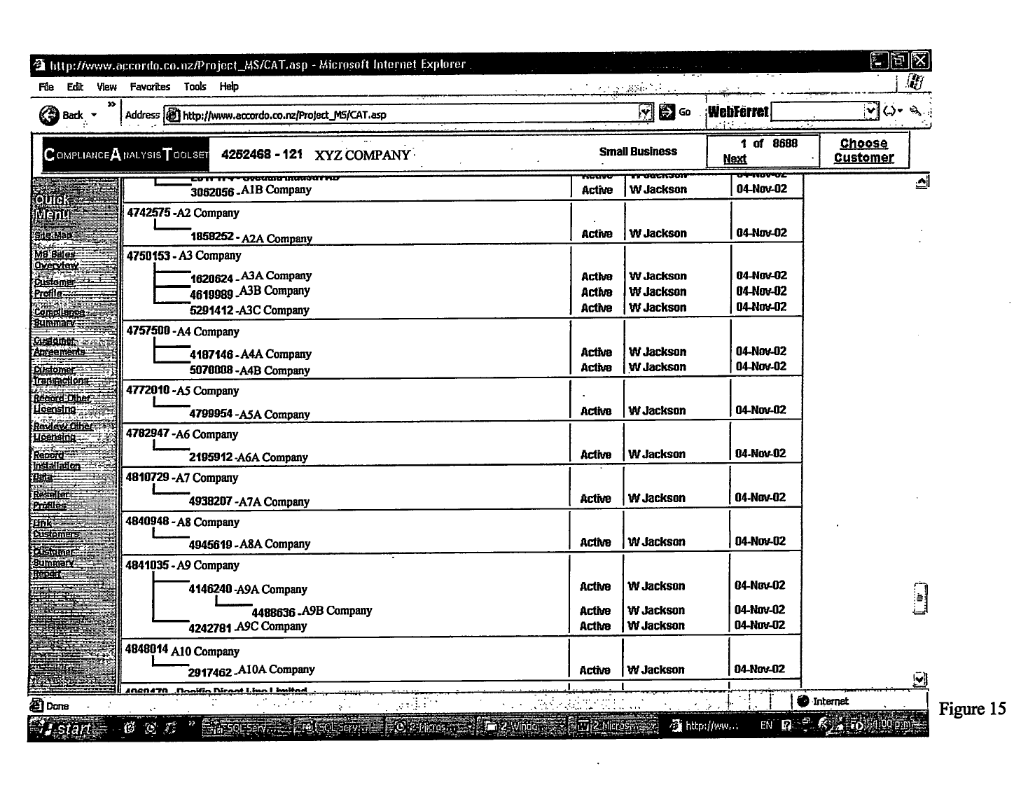

FIG. 15 shows how a list of customers and their links may be viewed.

In the example, A3 Company has three child company names. These are indicated as child company names by displaying them indented under the parent name. In addition a graphical characteristic, namely, an “L-shaped” branch points from the ID of parent name to the ID of child company name. It will appreciated that other graphical characteristics may be used.

In the example, A9 Company has two children. One of the children—A9A Company—has itself a child—A9B Company. This child (A9B) of a child is displayed in relation to its parent (A9A) in the same way that its parent (A9A) is displayed in relation to that parent's parent (A9).

The list also displays whether the link is active or not, who registered the link, and the date of registration.

Method for Linking Parent-Child Company Names

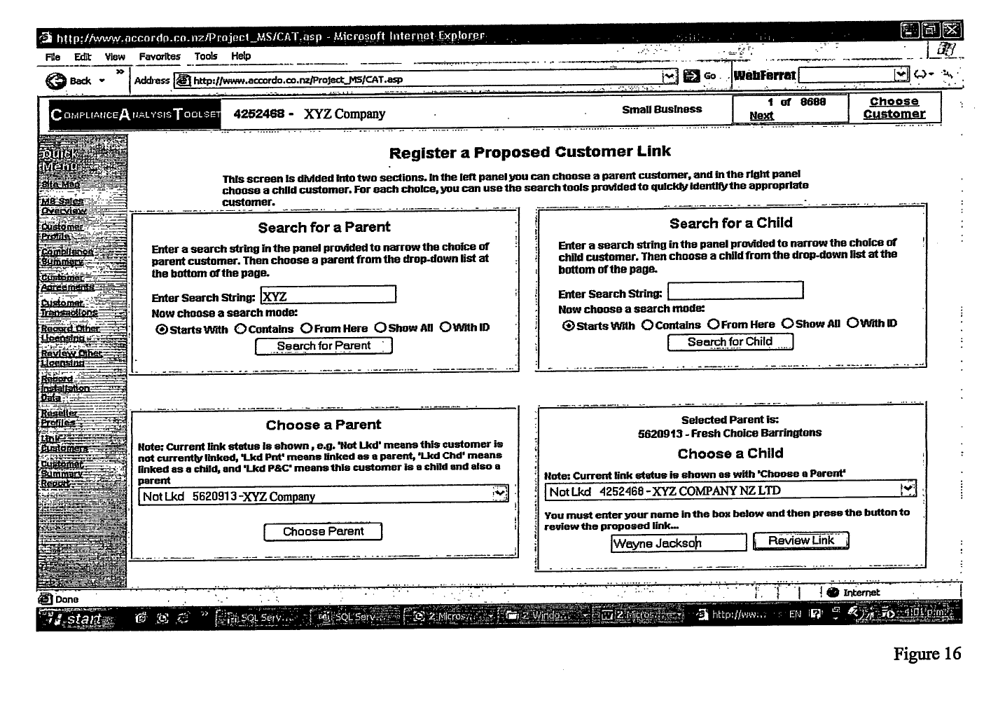

FIG. 16 shows how company names can be linked.

This example provides the ability to search for a parent company name by part of the name within the “Search for a Parent” pane. A search mode may also be selected, for example: starts with the part of the name entered or contains the part of the name entered.

The example also provides the ability to search for a proposed child company name by the same method within the “Search for a Child” pane.

When the “Search for Parent” button is actuated the parent list box in the “Choose a Parent” pane is populated with company names that match the search characteristics specified.

A parent company name may be selected from the parent list box.

When the “Search for Child” button is actuated the child list box in the “Choose a Child” pane is populated with company names that match the search characteristics specified.

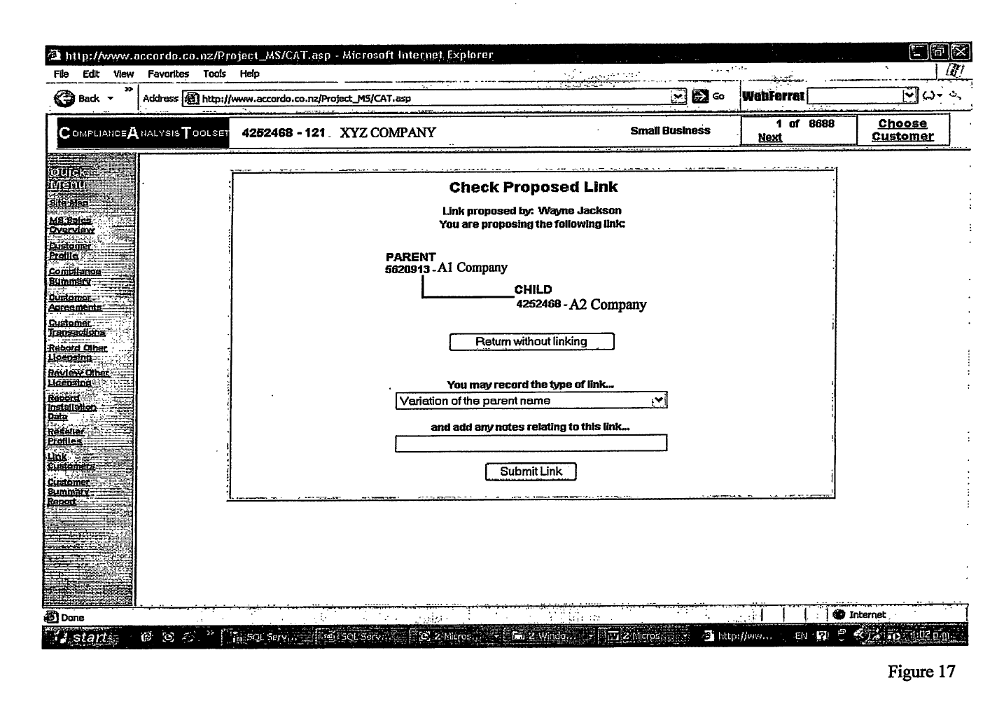

A proposed child company name may be selected from the child list box. When the “Review Link” button is actuated the screen shown in FIG. 17 appears and parent company name and proposed child company name may be linked.

Referring to FIG. 17, there are a number of different types of links that may be s made. The child company name may be a variation of the parent name, a subsidiary company of the parent company, or a former company name of the parent company.

Agreement Modelling

Numerous medium and large sized customer organizations require help to structure new licensing agreements particularly MICROSOFT™ licensing agreements. The aim of this method is to build the sophisticated functionality of a modelling tool as part of the invention.

The agreement modelling method can undertake the following functions:
a) an ability to capture the customer's “licensing roadmap”—i.e. their intended deployment of MICROSOFT™ products over the next 3-5 years;
b) the modelling of various relevant agreement options, showing total costs, annual costs, net-present-value considerations etc—with appropriate graphical comparisons;
c) the incorporation of the current LOP, as calculated by the licence ownership position (LOP) workbench. Any current non-compliance is factored into the various agreement options, and offset where appropriate.
d) a facility to capture and incorporate “intangible” costs, such as cost of administration, audit etc;
e) production of summary information and tables to support a recommendation for future action.

The agreement modelling method can calculate a customer's licensing options in relation to a vendor such as MICROSOFT™ by:
comparing Open Business, Open Volume, Select and Enterprise;
factoring in any international agreements options;
calculating appropriate levels for the individual pools;
providing annual year by year cost estimates;
factoring in NPV calculations;
providing the ability to capture and quantify some of the “soft” costs involved in administering licensing agreements to get a “real” reflection of the total cost of an agreement.

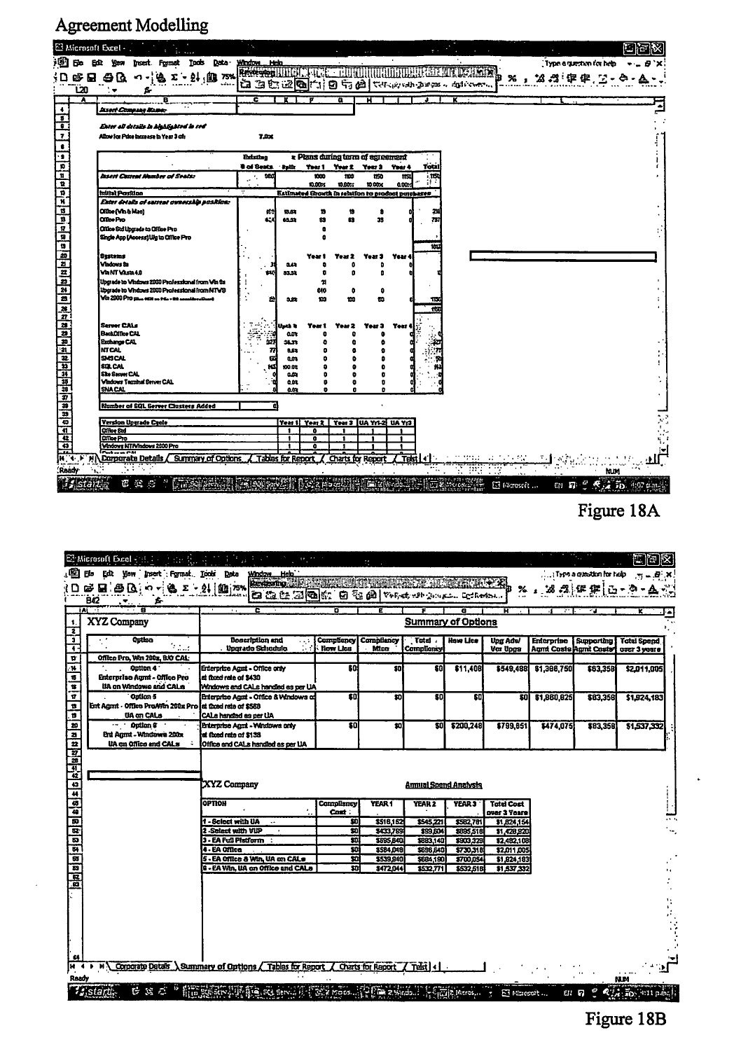

FIGS. 18A to 21 show the various ways in which appropriate licensing schemes for a customer may be calculated, displayed and compared.

FIG. 18A shows how an estimated yearly growth of licences required is calculated given the estimated yearly growth of the organisation.

FIG. 18B shows tables summarising possible licensing schemes for the organisation.

The first table shows the best possible options for the organisation. Each option has a description, a breakdown of costs and a total cost column.

The second table, Annual Spend Analysis, shows the cost per year of the licence options.

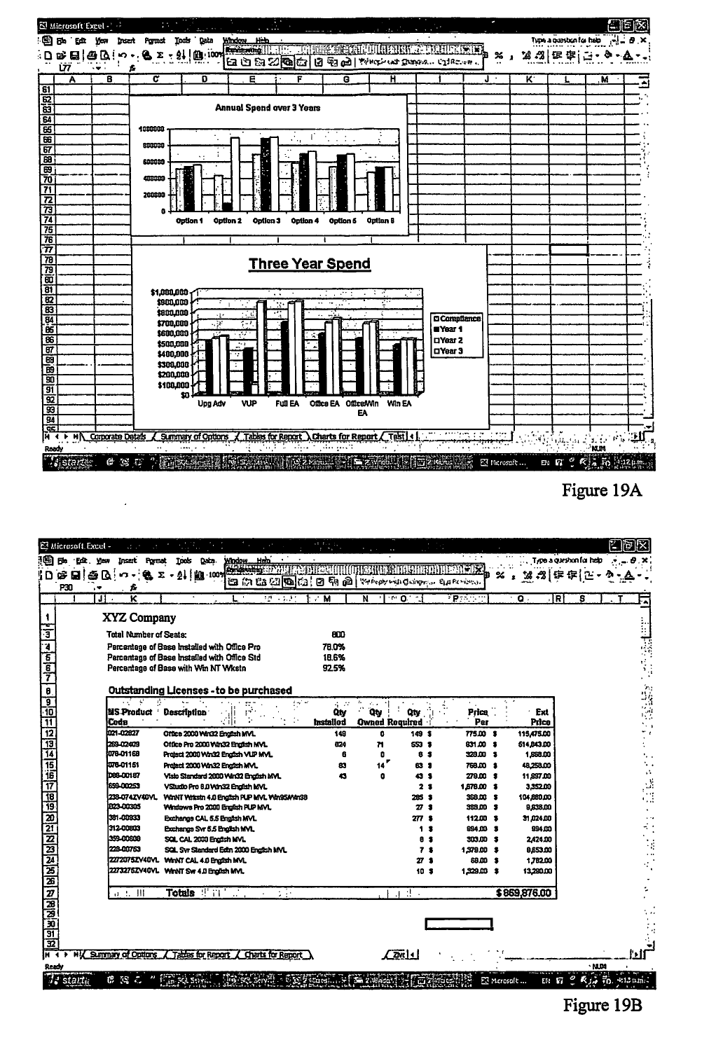

FIG. 19A shows several comparison graphs.

The first graph, Annual Spend over 3 Years, displays a cost bar per year for each of the years and for each of the options. In this example, 3 years are shown—the purple bar represents the cost for the first year, the red bar represents the cost for the second year, and the yellow bar represents the cost for the third year.

The second graph, Three Year Spend, displays yearly costs using bars for various agreement options.

The graphs enable easy visual comparisons to be made between the various licensing schemes (options).

FIG. 19B shows a table of the outstanding licences that are required to be purchased.

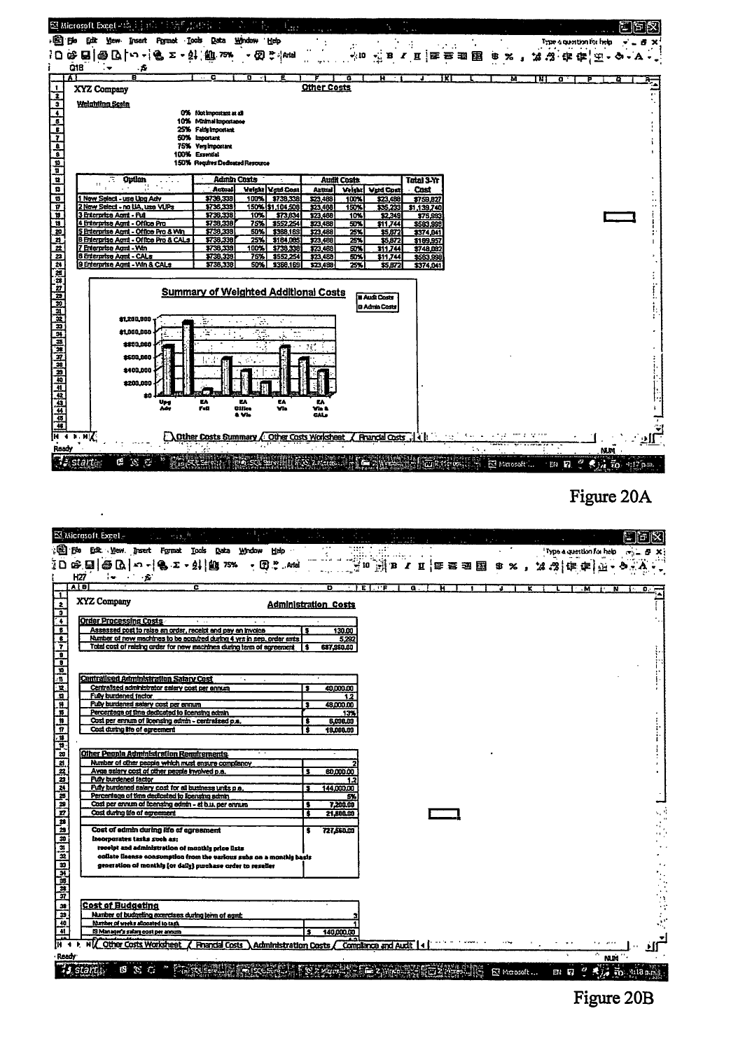

FIG. 20A shows a table and graph of the “soft” (e.g.administration, audit etc) costs after they have been weighted.

FIG. 20B shows a table which serves as a worksheet for the recording and calculation of administration, audit, and other “soft” costs.

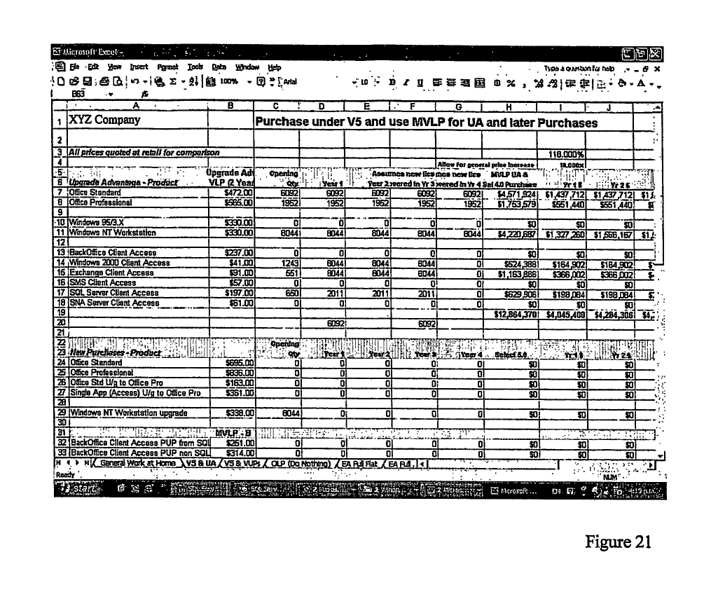

FIG. 21 shows an example of the calculation table for one of the agreement options, with products, purchase quantities and costs spread over a four year period.

Licence Ownership Position (LOP) Workbench

The display of licence ownership and compliance table method and method for the graphical display of ownership and compliance provide a LOP which is calculated by a series of algorithms, the aim being to offset upgrade licenses against available base licenses, apply maintenance transactions against base licenses etc. These algorithms are automatic and based on a set of rules and assumptions. However sophisticated these rules and assumptions may be, there are still instances where, as a result of contact with the customer, the rules and assumptions are seen to be providing a misleading or erroneous view of the actual license ownership position.

The method for generating the LOP provides the following functions:
a) display the automatically generated LOP, showing how transactions have been offset against each other;
b) manually apply information acquired through customer interaction, or other sources, to modify the standard calculation and create a new LOP;
c) store, retrieve and further refine this modified LOP until it represents the best possible analysis of that customers ownership position;
d) if a standard or derived LOP is accepted as a definitive ownership position by MICROSOFT™ and the customer, establish this LOP in the system as a confirmed position. This means that all future LOP calculations will take this confirmed position as the starting point for subsequent LOP calculations.

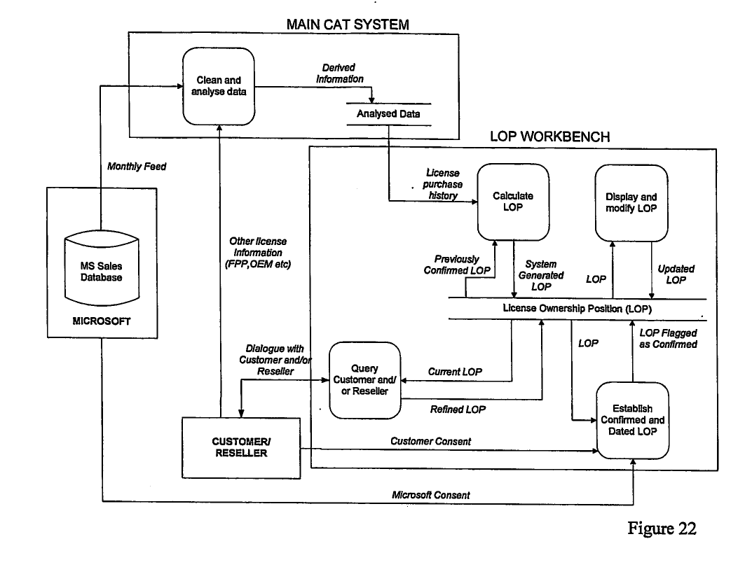

Referring to FIG. 22, the LOP workbench extracts licence purchase history from the Analysed Data (the analysis database) and calculates a system generated LOP. Previously calculated and recorded LOPs may also be used to calculate the system generated LOP.

The LOP can undergo a process of refinement which could include any number of the following steps:
The LOP may be displayed and modified by the user to provide additional, updated, or more reliable data. The Updated LOP can be recorded.
The customer or reseller can be queried to obtain additional, updated, or more reliable data. The Refined LOP can be recorded.
With the consent of the customer and the vendor, in this example MICROSOFT, the method can establish a confirmed and dated LOP. The recorded LOP may be flagged as confirmed as at a specified date.

In this example the data is provided from an analysis database created by the data flow method. It will be appreciated that the data may be retrieved from another source such as directly from the vendor database or from a third party source.

Review History

One of the primary aims of the invention is to assist people who interact with customers to review license compliance. This may be through call center activity, targeted on-site review activity, or other means. The various views and reports provided by the system give tools and raw material with which to perform this activity. As the work proceeds, new information will be uncovered, and the invention also aims to provide places for such relevant information to be stored, and, where appropriate, incorporated into future activity.

The purpose of the Review History section of the system is to allow the results and notes from previous engagements to be retrieved and reviewed before a fresh activity is undertaken.

For example, in New Zealand, numerous customer compliance reviews have been performed. In the course of this activity substantial information has been gathered which would be of great help to anyone embarking on future activity.

The intent of this method is to house this historical data for easy reference, and to provide a facility for the capture of new information as it is gathered.

Report on Customers

The aim of this section is to provide reporting options, specifically relating to the customer view.

This includes individual customer reports, such as a purchase summary, and also reports on all or part of the customer base.

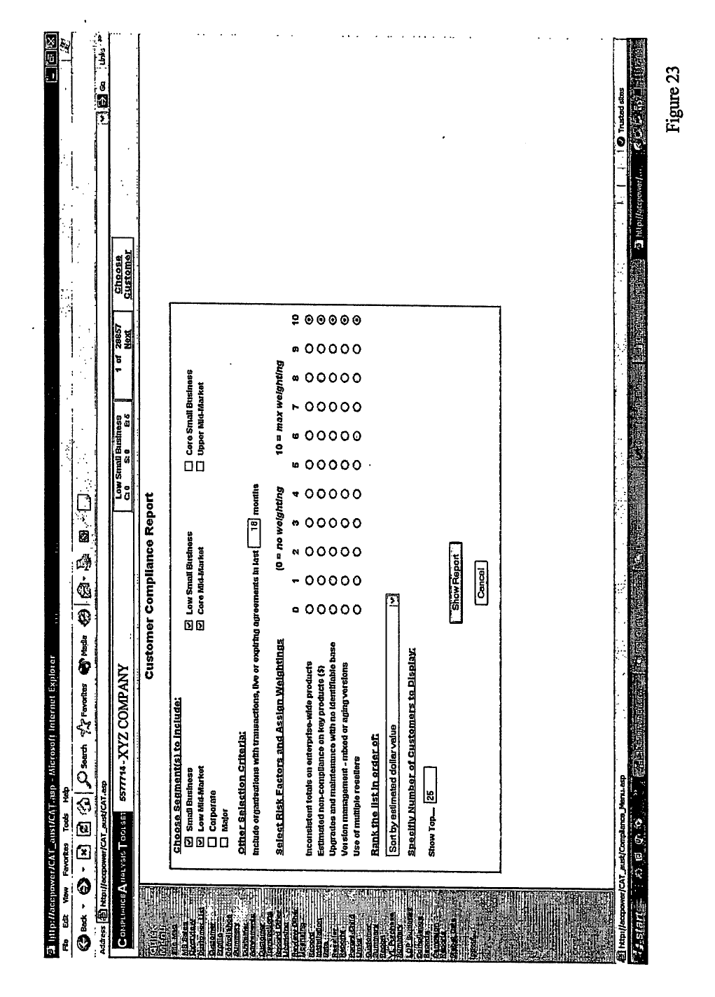

FIG. 23 shows a customer compliance metrics screen. Selection criteria may be entered on this screen to provide a list of customers who meet those criteria.

The criteria include customer segment such as small business, mid-market, or corporate.

This screen also provides for risk weightings to be given to certain aspects of the customer.

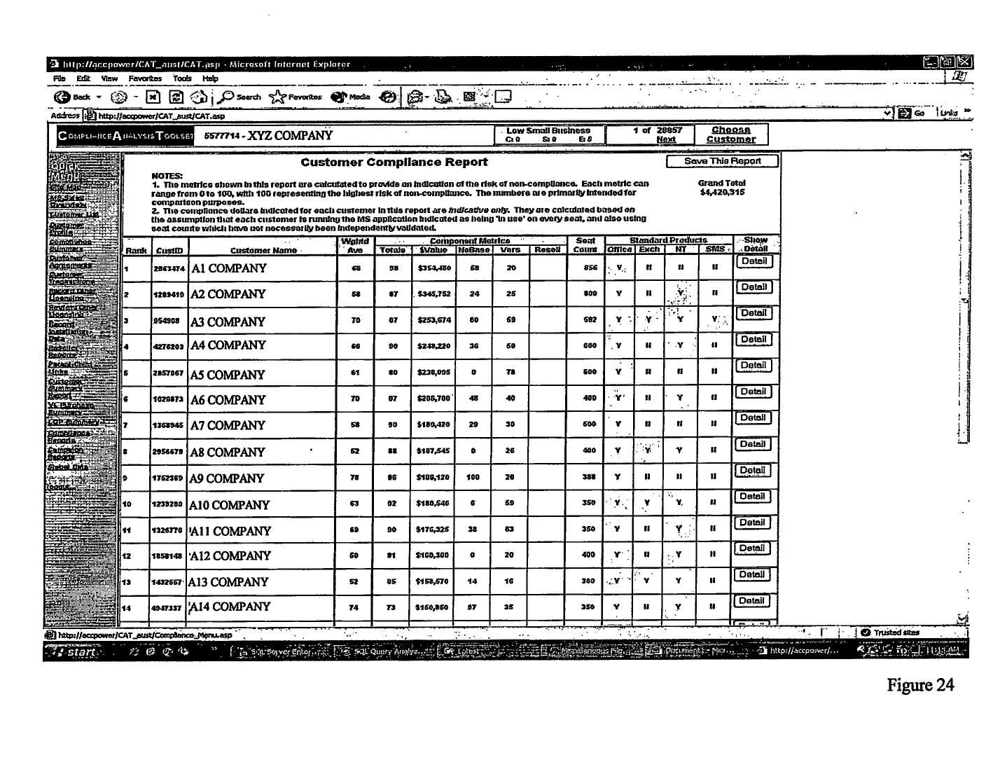

FIG. 24 shows a customer compliance report listing all the customers who meet the selection criteria entered in the screen shown in FIG. 22.

This report displays a rank list of customers selected according to the following criteria:
Organization characteristics, as displayed in the preceding menu screen
A table of pre-calculated metrics, used to measure the customer's risk of non-compliance. These metrics include the following risk factors:
   Inconsistent licence totals (e.g. disparity between PC count, Office licences and NT Client licences). Such disparities are measured and combined into a metric, which is used for comparison purposes.
   Inconsistent version use—including use of old versions, or use of multiple versions;
   Lack of base licences for upgrades and/or maintenance;
   Use of multiple resellers.

A dollar value is assigned based on the perceived discrepancies between licence totals and actual use.

The report presents a ranked list, which can be used as a basis for campaign activity and other customer contact.

The right hand columns indicate what assumptions have been made with regard to product use, and provide a means to edit this information.

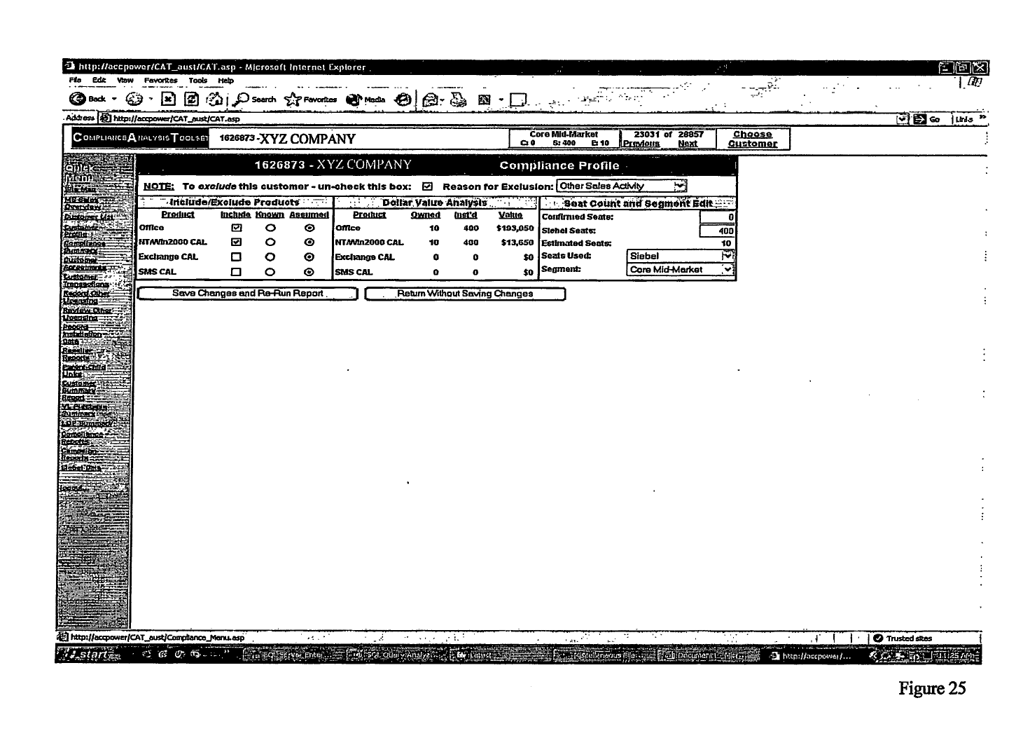

FIG. 25 shows a screen of how the detail shown in the report in FIG. 24 may be edited.

Customer Administration

This section is used to manage customer information which is not specifically derived from the MS Sales data. It is only available to people whose login grants appropriate permissions.

One of the most important customer administration functions is the creation and maintenance of parent-child links between customers. Anyone who has worked with MS Sales data will know that there is a large amount of duplication in terms of customer names and customer identifiers. For the system to coherently display analysed information pertaining to a customer, the appropriate links to transactions entered under a variation of the name must be in place.

However, wrongly created links are just as bad as missing links, so the establishment of links is restricted to appropriately authorised people. Anyone using the system will have the ability to propose a parent-child link, but not to activate it. A person with appropriate permissions must review the proposed link and decide whether it is to be activated or not.

There are a range of other administrative functions in the same category, such as the maintenance of seat count information, segment classification etc.

Reseller Analysis

The Reseller Profile screen provides a list of resellers from which summary information regarding any chosen reseller can be viewed. This summary information provides a graphical analysis of the activity of this reseller against broad criteria, such as agreement types and product pools.

The aim of this Reseller Analysis section is to provide much more detailed and in-depth analysis of resellers. Examples include:
a) the performance of a specific reseller across a particular product, group of products, or combination of products;
b) identification of the best and/or worst performing resellers against certain criteria. The criteria could relate to products, segments, agreement types, or some combination of these categories;
c) Comparisons can be made between similarly categorised resellers, as well as against the whole reseller population.

The advantage of this analysis tool is that a vendor such as MICROSOFT™ can provide their reseller community with significant enhanced value in being able to get a view of their customers licensing history in a format that is easily understood and can easily be worked with. For Large Account Resellers (LARs), access to any customers for whom they hold Select or Enterprise contracts will be immediately available. This will include the ability to view all license purchases for this customer (including Open). For resellers with Open customers, an authority request process with approval being gained from the customer prior to the information being made available will ensure resellers get access to only the information relevant to that customer and for a limited period of time.

Product Reports

The aim of this section is to provide reporting options, specifically relating to the reseller view.

This includes individual reseller reports, and also reports on all or part of the reseller population.

Reseller Administration

This section is used to manage reseller information which is not specifically derived from the MS Sales data. It is only available to people whose login grants appropriate permissions.

As with customers, the most important function is the creation and maintenance of parent-child links between reseller organisations which have been entered under different names, merged, or combined in some way. This is vital to ensure a coherent and representative view of the data pertaining to resellers.

Product List

The aim of this screen is to provide a searchable list of product information, as it pertains to MS Sales activity.

This list includes information such as product family name, version, release date, transaction types, part description, part number etc. The release dates have been gathered from a variety of sources and are as accurate as we have been able to make them. Where accurate information has not been available, we have used a best estimate.

It is also intended that this list give access to an estimated RRP for products in the current price list, and to an estimated replacement cost for obsolete products. The idea of an estimated replacement cost is to be able to gauge the value of non-compliant software.

Product Profile

The aim of this section is to provide graphical and tabular analysis of how a product, group of products, or combination of products have been purchased over a given time period. Purchases can be categorised according to a variety of criteria, including date range, transaction type (e.g. uptake of maintenance), upgrades versus standard purchase etc.

This section differs from the “Product Analysis” section of the Sales & Marketing View in that it relates to products in their own right—whereas the Sales & Marketing View provides product activity from a customer, reseller, segment, and agreement perspective.

Product Reports

The aim of this section is to provide reporting options, specifically relating to the product view.

This includes individual product reports, and also reports on groups or families of products.

Product Licensing Rules

In working with these tools and using them to analyse compliance and other licensing situations, it is often necessary to look up the literature on how a particular product is licensed. This information can be hard to find. Even harder to find is the set of rules that related to previous versions of a product—i.e. how it was licensed in the past. And yet, this information can have a significant bearing on a customer's current licensing position.

The aim of this section is to provide a repository of the principal licensing rules, searchable by product. Where possible, previous rules will also be referenced. The intention is that this repository will evolve over time, and when the rules change, as they frequently do, the previous set will not be lost, but retained for future reference. It is also intended to provide links to the rules from appropriate parts of the invention, so that they can be easily accessed while other work is being carried out.

Customer Segment Analysis

This section will provide graphical and tabular analysis of how the various customer segments (currently Major, Corporate, Upper Mid-Market, Core Mid-Market, Low Mid-Market, Core Small Business and Lower Small Business) have purchased according to MS Sales transaction records. It will allow comparisons showing which customer segments have purchased various products, agreement types, and maintenance contracts, over what periods, in what volumes etc.

Agreement Analysis

This section will provide graphical and tabular analysis of how the various agreement types (Enterprise, Select, Open) have been utilised, according to MS Sales transaction records. It will track the utilisation of these agreement types against the various customer segments, product families etc.

Product Analysis

This section will provide graphical and tabular analysis of how the various products, families of products, and combinations of products have been purchased, according to MS Sales transaction records. Comparisons can be made according to customer segment, agreement type, and also within given timeframes.

One of the primary features is the ability to produce a list of customers who have or have not purchased various products or product combinations. These extracts can be categorized by customer size, segment etc.

Simple examples could include:
a) list all Corporate customers who have purchased Windows 2000 Server, but not Exchange Server;
b) list all Core Mid-Market customers with a predominance of Windows NT 4.0;
c) list all Select customers who have little or no Software Assurance cover for desktop operating systems;
d) list all Major customers who have purchased some SQL Server but no SQL CALs;
   Annuity Renewal Analysis

Microsoft licenses which represent a contracted period (typically 2 or 3 years), during which term the customer automatically earns ownership of any new product versions, are referred to as annuity licences.

The invention can include several screens which are designed to provide information about annuity licences. In particular, these screens show what annuity licensing is coming up for renewal, the value of that licensing, and the details, such as product, reseller etc.

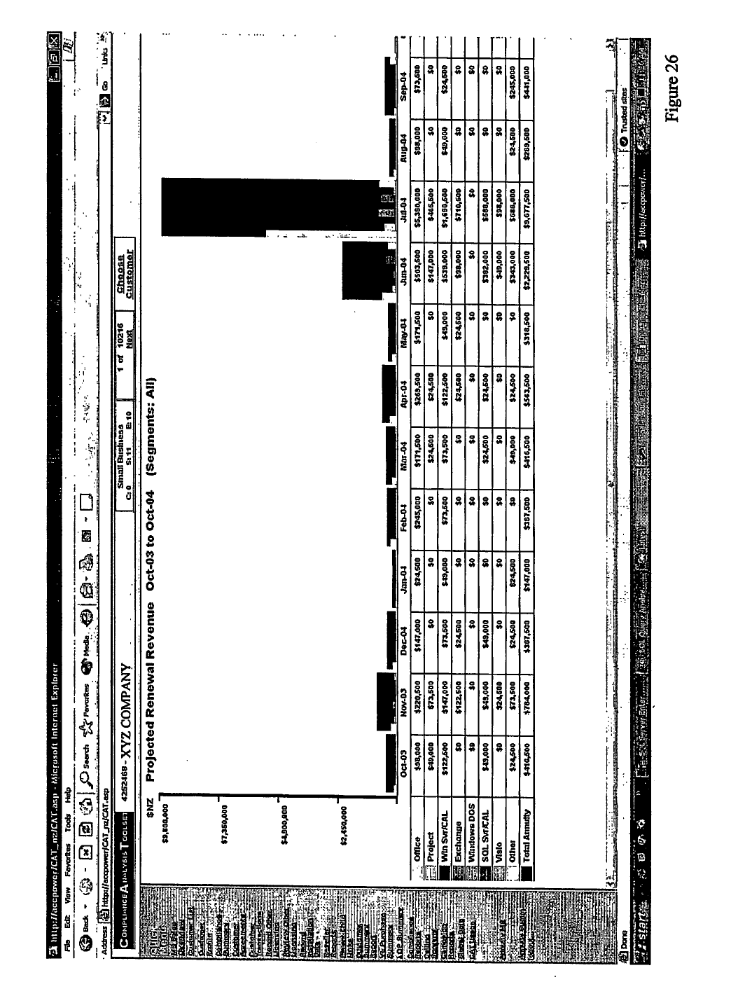

FIG. 26 shows an annual renewal projected revenue screen. This screen displays, in graphical and tabular format, the value of upcoming annuity renewals—with a breakdown by product group.

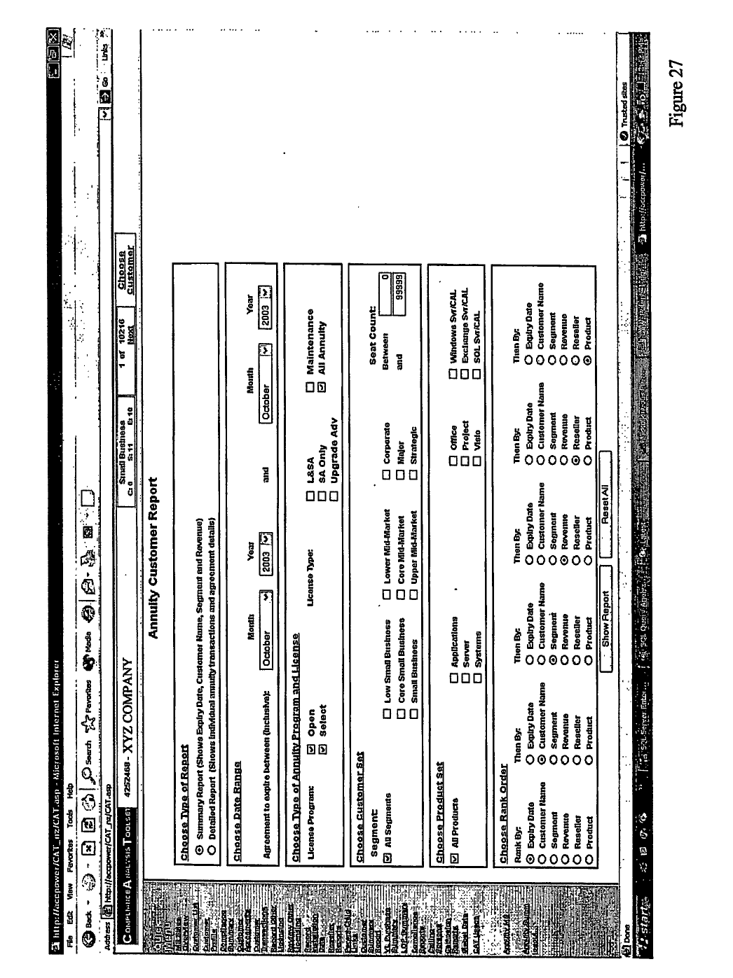

FIG. 27 shows a screen where criteria about customers regarding annuity programs may be defined.

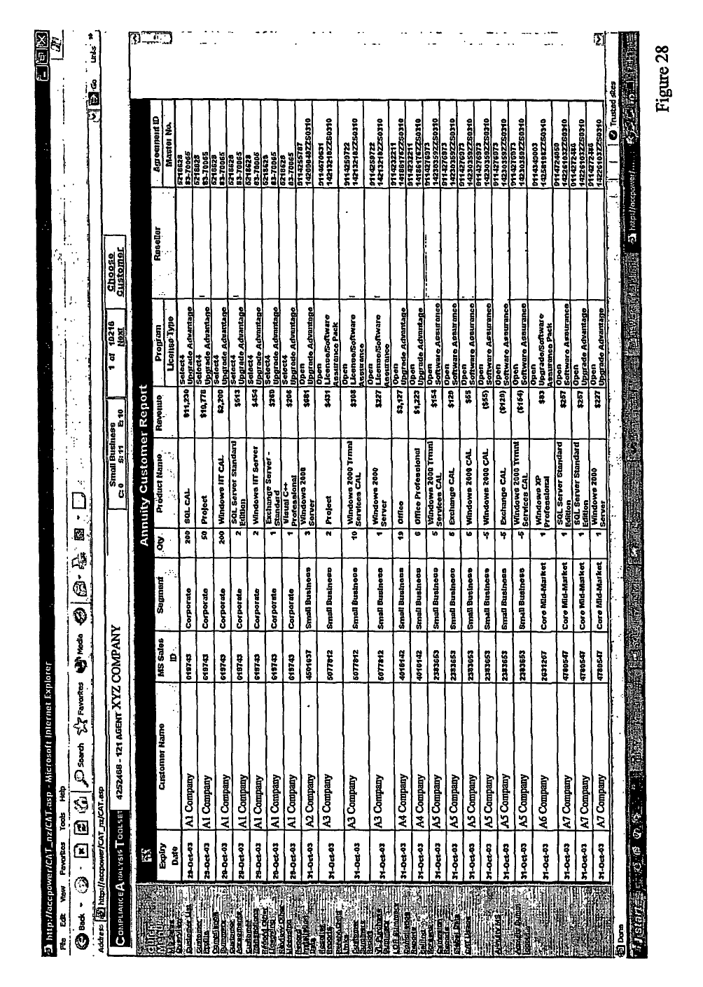

FIG. 28 shows a list of customers corresponding to the criteria entered in the screen in FIG. 27.

The invention can also provide screens to display annuity licensing for individual customers, in a format to send to the customer and screens to display annuity renewals based on a reseller selection—i.e. to allow a reseller to follow up on purchases made and encourage renewals.

Reseller Access

The intent of this module is to facilitate access to various areas of the invention for certain nominated and approved resellers. Participating resellers would be restricted to viewing information about those customers by whom authority has been granted. This authority is effectively already in place for Large Account Resellers, but would need to be explicitly obtained for Open customers.

The rationale behind providing this facility is that a better informed and better-equipped reseller channel will be more effective in securing licensing revenue in the first instance, and also of converting existing non-compliance to revenue.

Customer Access

The invention has the potential to provide an interface for individual customers, and thereby provide them with a coherent and comprehensive view of their volume license history, as well as analyzed interpretations and areas for investigation. An interface with an on-line audit tool can be incorporated to capture installation information with the customer's permission, and combine with the LOP to provide a picture of the customer's compliance status.

### ADVANTAGES OF THE INVENTION

The invention can be used to provide internal MICROSOFT™ users with analysed views of customer, product, and reseller activity based on volume license transactions. With the capacity to capture other license data together with installation information, customer organisations can be assessed in terms of license ownership and legal compliance status.

The invention provides the following advantages:

From a customer perspective, the invention provides the ability to:
view the customer's licence ownership position based on all license transactions and entitlements (including FPP, OEM, etc. where available);
be able to capture manual adjustments to the customers licence ownership position (with full audit tracking) to factor in any changes that may be uncovered through interaction with the customer;
freeze a customer's agreed licensing position (agreed by both MICROSOFT™ and the customer) as at a certain date—this is particularly useful for those customers where some compliance activity is undertaken and a position is finalised. This feature means that subsequent license analysis can commence from this established position, and repeated trawling through historical data can be avoided.;
produce Estimated License Ownership transcripts for forwarding to the customer—both electronically and in hard copy;
view customers from a compliance perspective;
view customers from a technology perspective—what MICROSOFT™ technology they using, and the extent of that use;
record licenses acquired outside of any MICROSOFT™ Volume Licensing programs (i.e. FPP, OEM, license transfers, technology guarantees, etc.);
record installation information as It becomes available from the customer;
view what resellers have been active with this customer, the period of activity, the products transacted, and the transaction volumes;
identify who is the incumbent reseller (where available);
create visible, auditable, and reversible parent-child links where multiple MsSales IDs exist for the same organisation;
estimate seat counts for comparative purposes;
produce reports such as who has:
   Upgrade Advantage/Software Assurance expiring;
   who has volume agreements expiring;
   who are the most appropriate customers to follow up from a compliance perspective (quantified in dollars);

From a reseller perspective, the invention provides the ability to:
create visible, auditable, and reversible parent-child links between resellers (especially useful for viewing and reporting on resellers from both a local office and national perspective);
categorise resellers based on their activity in certain customer segments;
additionally assign Influencers (as opposed to fulfilment resellers) to a customer for reporting purposes;
view resellers and assess how they are performing as compared to either the entire local market or reseller category across a number of comparative factors such as:
   customer segment;
   agreement type;
   product pool;
   number of transactions;
   number of licenses per agreement type;
   average number of licenses sold per transaction;
   individual products (e.g. how is this reseller performing with SQL as compared to the market generally or it's peers);
view an individual reseller's transaction activity;
report on resellers from a customer perspective;
provide resellers with a list of expiring UA/SA within their customer base, on an as required basis;
report on top performing resellers using a number of comparative factors such as:
   customer segment;
   agreement type;
   product pool;
   number of transactions;
   number of licenses per agreement type;
   average number of licenses sold per transaction;
   individual products (e.g. how is this reseller performing with SQL as compared to the market generally or it's peers);

From a product perspective, the invention provides the ability to:
analyse sales performance by product, and report on high/low performing products;
perform on-line product-customer queries (such as who has NT SERVER™ and is not entitled to WINDOWS 2000 SERVER™; who has WINDOWS SERVER™ but not EXCHANGE SERVER™, etc.)
and more

A further advantage is that all the information is available ON-LINE and UP-TO-DATE as of the most recent data feed.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of analysing software product licence data including the steps of:
i) receiving the data from a sales database;
ii) collating the data into an analysis database; and
iii) displaying an analysis of the data using the analysis database.

2. A method as claimed in claim 1 wherein the sales database is the database of a software product's vendor.

3. A method as claimed in claim 1 wherein the data from the sales database includes transaction data about volume licence sales to customers.

4. A method as claimed in claim 1 wherein the data includes products lists of available software products.

5. A method as claimed in claim 1 wherein the data is received from a vendor sales database in a batch feed.

6. A method as claimed in claim 5 wherein the batch feed occurs in any one of monthly, bi-weekly, or weekly.

7. A method as claimed in claim 1 wherein data received from the sales database is cleaned before it is collated into the analysis database.

8. A method as claimed in claim 7 wherein cleaning the data includes correcting inconsistencies in transaction data or inconsistencies with the existing analysis database.

9. A method as claimed in claim 7 wherein cleaning the data includes determining new products from the product list and updating the analysis database.

10. A method as claimed in claim 1 including the step of:
iv) interacting with the customers of the vendor to obtain correct customer data, other licence data, and actual software installation data.

11. A method as claimed in claim 10 wherein the data obtained in step (iv) is incorporated into the analysis database.

12. A method as claimed in claim 11 wherein step (iv) is performed by:
i) prompting questions to ask a customer;
ii) recording the responses given by the customer; and
iii) integrating the responses into the analysis database.

13. A method as claimed in claim 1 wherein the data analysis includes an assessment of licence ownership.

14. A method as claimed in claim 13 wherein the assessment of licence ownership is displayed for each customer in a summary screen showing products owned by the customer, licences owned for those products by the customer, and a total assessed ownership for each product for the customer.

15. A method as claimed in claim 14 wherein the summary screen further includes a section showing upgrade licences owned by the customer.

16. A method as claimed in claim 15 wherein the section indicates if additional upgrade licences are required, where upgrade licenses have no identifiable base license.

17. A method as claimed in claim 13 wherein the display of the assessment of licence ownership includes an option to view a derivations screen showing the derivation of calculations in the summary screen.

18. A method as claimed in claim 1 wherein the data analysis includes an assessment of licence compliance.

19. A method as claimed in claim 18 wherein the assessment of licence compliance is displayed for each customer in a summary screen showing (a) products/licences owned by the customer, (b) products actually installed/used by the customer, and the discrepancy between (a) and (b).

20. A method as claimed in claim 1 wherein the data analysis includes one or more from the set of transaction data analysis, licence agreement analysis, reseller analysis, customer compliance lists, customer segment analyses, product analysis, and annuity renewal analysis.

21. A method as claimed in claim 1 including the step of:
v) a user specifying criteria to determine how the data is to be analysed or what portion of the data is to be analysed;
wherein step (v) occurs before step (iii).

22. A method as claimed in claim 21 wherein the data analysis is a customer compliance list and the criteria includes one or more from the set of designating the segment of business, assigning risk weightings to one or more factors, designation of list order, and a time frame.

23. A method as claimed in claim 21 wherein the data analysis is an annuity renewal analysis and the criteria includes one or more from the set of a data range, types of annuity programs/licences, designation of the segment of business, product set, and designation of list order.

24. A method as claimed in claim 1 wherein the data analysis is displayed on a GUI.

25. A method as claimed in claim 1 including the step of:
vi) receiving customer data from a vendor CRM database and integrating it into the analysis database.

26. A method as claimed in claim 1 including the step of:
vii) transmitting corrected customer data to a vendor CRM database.

27. A method of displaying an analysis of software product licence data including the steps of:
i) displaying an assessment of the number of computer users in an organisation using a first graphical characteristic; and
ii) displaying the current number of software product licences owned by the organisation for products of a vendor using a second graphical characteristic.

28. A method as claimed in claim 27 wherein the second graphical characteristic consists of bars representing each product and the first graphical characteristic is a line, perpendicular to the direction of the bars, overlaid on the bars.

29. A method as claimed in claim 28 wherein the bars are colour-coded to indicate the different types of licenses.

30. A method as claimed in claim 28 wherein a plurality of licence types exist for a product that bar may be coded the colour of the numerically dominant licence type and the other licences may be represented as smaller bars overlaid on this bar.

31. A method as claimed in claim 28 wherein each bar represents a licence ownership position for the corresponding product for the organisation and the licences are represented as smaller bars overlaid on this bar.

32. A method of displaying a licence ownership position for a vendor's software products for a customer including the steps of:
i) retrieving software product licensing data from a sales database;
ii) retrieving other software product licence data from the customer;
iii) retrieving assessed use of the software products by the customer;
iv) calculating a licence ownership position; and
v) displaying the licence ownership position and assumptions about calculations in a GUI.

33. A method as claimed in claim 32 wherein the licence ownership position is calculated using one or more of the following factors the number/estimated number of computer users in the customer's organisation, the number of commercial licences sold to the customer, the relationship between base licenses, upgrade licenses, and licences accrued via maintenance contracts, other licences owned by the customer, and various assumptions.

34. A method as claimed in claim 32 wherein the licence ownership position is calculated by combining different licence types and aggregating purchases totals.

35. A method as claimed in claim 32 wherein the data in steps (i) to (iii) is retrieved from an analysis database created by:
i) receiving the data from a sales database; and
ii) collating the data into an analysis database.

36. A method as claimed in claim 32 wherein the sales database is the sales database of the vendor.

37. A method as claimed in any one of claims 32 to 35 claim 32 including the step of:
vi) calculating and displaying the risk of non-compliance.

38. A method as claimed in claim 37 wherein step (vi) includes the step of comparing the licence ownership position to actual installation data or actual/estimated computer user data.

39. A method as claimed in claim 32 wherein the licence ownership position is recorded and used when later licence ownership positions are calculated.

40. A method as claimed in claim 32 wherein the licence ownership position may be refined by providing more data or more reliable data.

41. A method of determining software product licensing schemes for a customer including the steps of:
i) retrieving data from an analysis database created during the method of claim 1;
ii) retrieving customer requirement data; and
iii) calculating possible licence schemes.

42. A method as claimed in claim 41 wherein the data retrieved from the analysis database includes current compliance or non-compliance with licensing schemes by the customer, and data about existing software product licences owned by the customer.

43. A method as claimed in claim 41 wherein the customer requirement data includes intended deployment of software products over a specified time and “soft cost” data relating to administration costs of certain types of licensing schemes.

44. A method as claimed in claim 41 wherein the licence schemes include total costs, annual costs, and net-present-value considerations.

45. A method as claimed claim 41 includes the step of:
iv) displaying a graphical comparison of the licence schemes.

46. A method as claimed in claim 41 including the step of selecting the best possible or most appropriate licensing schemes for the customer.

47. A method of recording customer data including the steps of:
i) prompting questions to ask a customer;
ii) recording the responses given by the customer; and
iii) integrating the responses into an analysis database created during the method of claim 1.

48. A method as claimed in claim 47 wherein the questions include questions relating to software users within the customer's organisation and general details about the organisation, and questions designed to assist the capture of anecdotal information about product use, user counts, and non-volume licence purchases.

49. A method as claimed in claim 47 wherein the types of questions prompted may be determined by the lack of certain data, the existence of certain data, or the reliability of certain data within the analysis database.

50. A method as claimed in claim 47 wherein the responses recorded automatically update the analysis database and further questions may be based on responses previously supplied.

51. A method as claimed in claim 47 including the step of retrieving compliance/non-compliance data from the analysis database.

52. A method as claimed in claim 51 wherein the data may be used to direct the focus of the questions prompted.

53. A method as claimed in claim 47 wherein the questions are asked during a calling campaign.

54. A method as claimed in claim 47 wherein the responses are integrated into a campaign table within the analysis database.

55. A method for selecting a software product of a vendor including the sequentially occurring steps of:
i) displaying a plurality of panes within a GUI;
ii) selecting a product type from a list of product types under category headings within a first pane;
iii) selecting a product variation from a list of product variations within a second pane; and
iv) selecting a product version from a list of product versions within a third pane.

56. A method as claimed in claim 55 wherein the software products comply with MICROSOFT™ labelling methodology.

57. A method as claimed in claim 55 wherein the first pane lists the vendor's most popular product types under each category.

58. A method as claimed in claim 57 wherein the category headings under the first pane include “Applications”, “Servers”, and “Systems”.

59. A method as claimed in claim 55 including the step of selecting a licence type of the software product within the third pane.

60. A method as claimed in claim 55 wherein the selection of a product type within the first pane determines the product variations listed in the second pane.

61. A method as claimed in claim 55 wherein selection of the product type is confirmed by actuation of a button within the first pane.

62. A method as claimed in claim 55 wherein the selection of a product variation within the second pane determines the product versions listed in the third pane.

63. A method as claimed in claim 55 wherein selection of the product variation is confirmed by actuation of a button within the second pane.

64. A method as claimed in claim 55 wherein the method is used to record or update actual installation data of the software product in a customer's organisation.

65. A method for linking two company names including the steps of:
i) entering a first company name abbreviation in a first region;
ii) populating a first list within a second region with company names which correspond to the first company name abbreviation;
iii) selecting a first company name from the list;
iv) entering a second company name abbreviation in a third region;
v) populating a second list within a fourth region of company names which correspond to the second company name abbreviation;
vi) selecting a second company name from the second list; and
vii) linking the first company name with the second company name.

66. A method as claimed in claim 65 wherein the company names are linked because the first company name is the parent or child of the second company name, the first company name is the former or present name of the second company name, or the first company name is an alternative name of the second company name.

67. A method as claimed in claim 65 wherein the first and second company name abbreviations may be a search string for a part of a company name.

68. A method as claimed in claim 65 wherein the first and second lists include the company name and its link status.

69. A method as claimed in claim 68 wherein the link status is any one of the set of not linked, a parent, and a child.

70. A method for displaying linked company names including the steps of:
i) displaying a list of one or more primary company names;
ii) displaying under each primary company name one or more secondary company names linked to the primary company name; and
iii) displaying one or more graphical characteristics each representing the link between each secondary company name and its corresponding primary company name.

71. A method as claimed in claim 70 wherein the company names are linked because the primary company name is the parent of the secondary company name, the secondary company name is the former name of the primary company name, or the secondary company name is an alternative name of the primary company name.

72. A method as claimed in claim 70 wherein the secondary company is displayed under and indented with respect to the primary company name.

73. A method as claimed in claim 70 including the step of displaying one or more tertiary company names each linked to a secondary company name under their respective secondary company names and one or more graphical characteristics representing each link.

74. A method as claimed in claim 70 wherein the graphical characteristics used to represent the link are “L-shaped” branches.

75. A system for implementing the method of claim 1.

76. Software for effecting method or system of claim 1.
